(19) United States
(12) Patent Application Publication
(10) Pub. No.: US 2026/0370885 A1
(43) Pub. Date: Nov. 19, 2026

(54) POINT CLOUD DECODING METHOD, ENCODER, AND DECODER

(71) Applicant: GUANGDONG OPPO MOBILE TELECOMMUNICATIONS CORP., LTD., Dongguan (CN)

(72) Inventor: Zexing SUN, Dongguan (CN)

(21) Appl. No.: 19/728,659

(22) Filed: Jul. 2, 2026

Related U.S. Application Data
(63) Continuation of application No. PCT/CN2024/071655, filed on Jan. 10, 2024.

(51) Int. Cl. H04N 19/70; H04N 19/136; H04N 19/169

(52) U.S. Cl. CPC H04N 19/70; H04N 19/136; H04N 19/1883

(57) ABSTRACT

A point cloud encoding method, a point cloud decoding method, an encoder, a decoder, a bitstream, and a storage medium are provided in embodiments of the disclosure. The point cloud decoding method includes the following. A bitstream is parsed to determine first flag information. Attribute information of a current layer is decoded according to the first flag information. The current layer is any one of multiple region adaptive hierarchical transform (RAHT) layers. The first flag information indicates whether a first decoding manner or a second decoding manner is to be used for the current layer. In the first decoding manner, nodes in the current layer correspond to the same decoding mode. In the second decoding manner, decoding modes for nodes in the current layer need to be determined respectively.

### CROSS-REFERENCE TO RELATED APPLICATION (S)

This application is a continuation of International Application No. PCT/CN2024/071655, filed Jan. 10, 2024, the disclosure of which is hereby incorporated by reference in its entirety.

### TECHNICAL FIELD

This disclosure relates to the field of point cloud coding technology, in particular to a point cloud decoding method, an encoder, and a decoder.

### BACKGROUND

In a point cloud coding framework, a region adaptive hierarchical transform (RAHT)-based coding scheme may be enabled during coding of attribute information of a point cloud. However, a current RAHT-based coding scheme has a problem of low coding efficiency.

### SUMMARY

In a first aspect, a point cloud decoding method is provided. The method is applied to a decoder and includes the following. A bitstream is parsed to determine first flag information. Attribute information of a current layer is decoded according to the first flag information. The current layer is any one of multiple region adaptive hierarchical transform (RAHT) layers. The first flag information indicates whether a first decoding manner or a second decoding manner is to be used for the current layer. In the first decoding manner, nodes in the current layer correspond to the same decoding mode. In the second decoding manner, decoding modes for nodes in the current layer need to be determined respectively.

In a second aspect, a decoder is provided. The decoder includes at least one processor and a memory. The memory is coupled to the at least one processor and stores at least one computer executable instruction. When executed by the at least one processor, the at least one computer executable instruction causes the at least one processor to perform the method of the first aspect.

In a third aspect, an encoder is provided. The encoder includes at least one processor and a memory. The memory is coupled to the at least one processor and stores at least one computer executable instruction. When executed by the at least one processor, the at least one computer executable instruction causes the at least one processor to: determine a cost of a first encoding manner and a cost of a second encoding manner; and encode attribute information of a current layer according to the cost of the first encoding manner and the cost of the second encoding manner. The current layer is any one of multiple RAHT layers, in the first encoding manner, nodes in the current layer correspond to a same encoding mode, and in the second encoding manner, encoding modes for nodes in the current layer need to be determined respectively.

### BRIEF DESCRIPTION OF THE DRAWINGS

FIG. 1A is a schematic diagram of a three-dimensional (3D) point cloud picture.

FIG. 1B is a partial enlarged view of a 3D point cloud picture.

FIG. 2A is a schematic diagram illustrating six viewing angles of a point cloud picture.

FIG. 2B is a schematic diagram of a data storage format of a point cloud picture.

FIG. 3 is a schematic diagram of a network architecture of point cloud coding.

FIG. 4A is a schematic diagram of a framework of a geometry-based point cloud compression (G-PCC) encoder.

FIG. 4B is a schematic diagram of a framework of a G-PCC decoder.

FIG. 5A is a schematic diagram illustrating low plane positions in a Z-axis direction.

FIG. 5B is a schematic diagram illustrating high plane positions in a Z-axis direction.

FIG. 6 is a schematic diagram of a node encoding order.

FIG. 7A is a schematic diagram of planar flag information.

FIG. 7B is another schematic diagram of planar flag information.

FIG. 8 is a schematic diagram of sibling nodes of a current node.

FIG. 9A is a schematic diagram illustrating three vertices in a block.

FIG. 9B is a schematic diagram illustrating a triangle soup (trisoup) fitted using three vertices.

FIG. 9C is a schematic diagram illustrating up-sampling of a trisoup.

FIG. 10 is a schematic diagram illustrating distance-based level of detail (LOD) construction.

FIG. 11 is a schematic diagram illustrating generation of a distance-based LOD point cloud.

FIG. 12 is a schematic diagram illustrating encoding of attribute information of an LOD point cloud.

FIG. 13 is a schematic structural diagram illustrating refinement levels based on LOD partitioning.

FIG. 14 is a schematic diagram illustrating LOD-based inter-layer nearest-neighbour search.

FIG. 15A is a schematic diagram illustrating a spatial relationship between a block and a parent block.

FIG. 15B is a schematic diagram illustrating neighbouring blocks that are coplanar, collinear, or concurrent with a current parent block.

FIG. 16 is a schematic diagram illustrating a manner of nearest-neighbour search for a current point.

FIG. 17 is a schematic diagram illustrating a manner of intra-layer nearest-neighbour search for attribute information.

FIG. 18 is a schematic diagram illustrating a manner of fast search within an LOD layer.

FIG. 19 is a schematic diagram of a prediction structure for neighbourhood search based on Morton code.

FIG. 20 is a schematic diagram illustrating a process of lifting transform coding.

FIG. 21 is a diagram of an example of region adaptive hierarchical transform (RAHT) transform.

FIG. 22 is another diagram of an example of RAHT transform.

FIG. 23 is a schematic diagram illustrating RAHT transform and RAHT inverse transform.

FIG. 24 is a schematic diagram of a structure of a coding block for attribute information.

FIG. 25 is a schematic diagram of an overall process of intra prediction combined transform coding of attribute information.

FIG. 26 is a diagram of an example linear fitting manner of neighbourhood attribute information of a current block.

FIG. 27 is a schematic diagram illustrating RAHT intra prediction transform coding of attribute information.

FIG. 28 is a schematic flowchart of inter prediction of attribute information of an RAHT layer.

FIG. 29 is a schematic structural diagram of an RAHT layer.

FIG. 30 is a schematic flowchart of a decoding method provided in embodiments of the disclosure.

FIG. 31 is a schematic flowchart of an encoding method provided in embodiments of the disclosure.

FIG. 32 is a schematic flowchart of an encoding method provided in embodiments of the disclosure.

FIG. 33 is another schematic flowchart of an encoding method provided in embodiments of the disclosure.

FIG. 34 is a schematic flowchart of a decoding method provided in embodiments of the disclosure.

FIG. 35 is another schematic flowchart of a decoding method provided in embodiments of the disclosure.

FIG. 36 is a schematic structural diagram of a decoder provided in an embodiment of the disclosure.

FIG. 37 is a schematic structural diagram of a decoder provided in another embodiment of the disclosure.

FIG. 38 is a schematic structural diagram of an encoder provided in an embodiment of the disclosure.

FIG. 39 is a schematic structural diagram of an encoder provided in another embodiment of the disclosure.

### DETAILED DESCRIPTION

To enable a more detailed understanding of features and technical content in embodiments of the disclosure, the embodiments of the disclosure will be described in detail below with reference to the accompanying drawings, which are provided for illustrative purposes only and are not intended to limit embodiments of the disclosure.

Unless otherwise defined, all technical and scientific terms used herein have the same meaning as commonly understood by those skilled in the art. The terms used herein are for the purpose of describing embodiments of the disclosure only and are not intended to limit the disclosure.

In the following description, reference to “some embodiments” describes a subset of all possible embodiments, but it will be understood that “some embodiments” may refer to the same or different subsets of all possible embodiments and may be combined with each other without conflict.

It may be further noted that the terms “first/second/third” in embodiments of the disclosure are merely for distinguishing similar objects and do not imply a particular ordering with respect to the objects, and it will be understood that “first/second/third” may, where appropriate, be interchanged in a particular order or sequence so that embodiments of the disclosure described herein can be implemented in an order other than that illustrated or described herein.

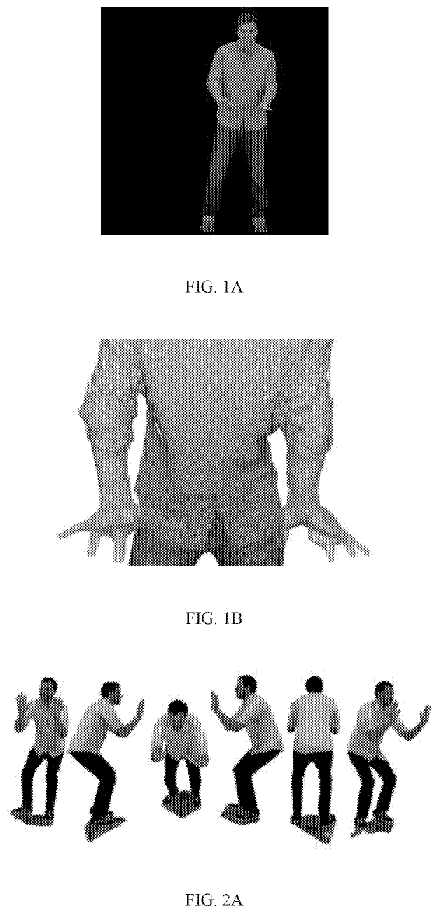

Point cloud is a collection of irregularly-distributed discrete points in space that represent the spatial structure and surface attributes of a three-dimensional (3D) object or scene. These points contain geometry information for representing spatial positions and attribute information for representing appearance textures of the point cloud. FIG. 1A illustrates a 3D point cloud picture, and FIG. 1B is a partial enlarged view of a 3D point cloud picture. As can be seen, a surface of the point cloud is composed of densely-distributed points.

Since a two-dimensional picture has information representation at each pixel distributed regularly, position information thereof does not need to be recorded additionally. However, since points in the point cloud are distributed randomly and irregularly in 3D space, a position of each point in the space needs to be recorded, so that the point cloud can be represented completely. Similar to the two-dimensional picture, each position has corresponding attribute information in a collection process, that is, usually a red green blue (RGB) colour value. A colour value reflects a colour of an object. For the point cloud, in addition to colour information, the attribute information corresponding to each point often includes a reflectance value. The reflectance value reflects a surface material of an object. Therefore, point cloud data usually includes position information of the point and attribute information of the point. The position information of the point may also be referred to as geometry information of the point. For example, the geometry information of the point may be 3D coordinate information (x, y, z) of the point. The attribute information of the point may include colour information and/or reflectance, etc. For example, the reflectance may be one-dimensional reflectance information (r); and the colour information may be information on any colour space, or the colour information may be 3D colour information, such as RGB information. Herein, R represents red, G represents green, and B represents blue. Another example of the colour information may be luminance-chrominance (YCbCr, YUV) information, where Y represents brightness (luma), Cb (U) represents blue chrominance, and Cr (V) represents red chrominance.

For a point cloud obtained based on laser measurement, a point in the point cloud may include 3D coordinate information of the point and a reflectance value of the point. For a point cloud obtained based on photogrammetry, a point in the point cloud may include 3D coordinate information of the point and 3D colour information of the point. For a point cloud obtained based on laser measurement and photogrammetry, a point in the point cloud may include the 3D coordinate information of the point, the reflectance value of the point, and the 3D colour information of the point.

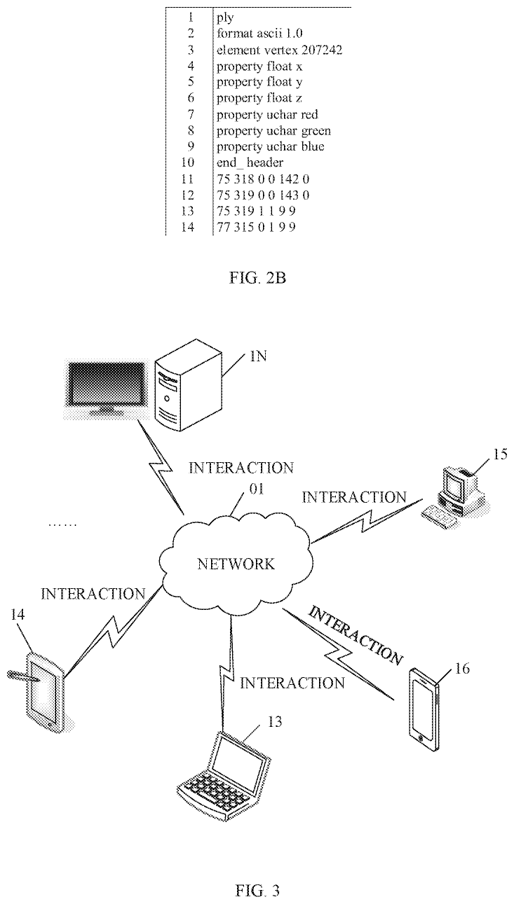

FIG. 2A and FIG. 2B illustrate a point cloud picture and a data storage format of the point cloud picture, respectively. FIG. 2A provides six viewing angles of the point cloud picture. FIG. 2B consists of header information and data. The header information contains a data format, a data representation type, the total point number of the point cloud, and the content represented by the point cloud. For example, the point cloud is in “.ply” format and represented by ASCII codes, with the total point number of 207242. Each point has 3D coordinate information (x, y, z) and 3D colour information (r, g, b).

Point clouds may be classified according to the obtaining manners as:
a static point cloud, i.e., the object is stationary and the point cloud obtaining device is also stationary;
a dynamic point cloud: the object is in motion, but the point cloud obtaining device is stationary; and
a dynamically-obtained point cloud: the point cloud obtaining device is in motion.

For example, point clouds may be classified into two main categories according to usage:
category 1: machine perception point cloud, which may be used in scenarios such as autonomous navigation systems, real-time inspection systems, geographic information systems, visual sorting robots, and rescue and disaster relief robots; and
category 2: human eye perception point cloud, which may be used in scenarios such as digital cultural heritage, free point-of-view broadcasting, 3D immersive communication, and 3D immersive interaction.

The point cloud can represent the spatial structure and surface attributes of the 3D object or scene in a flexible and convenient manner. In addition, since the point cloud is obtained by directly sampling a real object, which can exhibit an extremely realistic effect on the premise of ensuring accuracy, the point cloud has a wide range of application, including virtual reality games, computer-aided design, geographic information systems, autonomous navigation systems, digital cultural heritage, free point-of-view broadcasting, 3D immersive telepresence, 3D reconstruction of biological tissues and organs, and the like.

The point cloud may be mainly collected in the following ways: computer generation, 3D laser scanning, 3D photogrammetry, and the like. Point cloud of a virtual 3D object or scene may be generated by the computer. Point cloud of a 3D object or scene in a static real world may be obtained through 3D laser scanning, with millions of points obtained every second. Point cloud of a 3D object or scene in a dynamic real world may be obtained through 3D photogrammetry, with tens of millions of points obtained every second. These technologies have reduced the acquisition cost and the time period of point cloud data, and improved the accuracy of the data. The transformation of the method for acquiring point cloud data makes it possible to acquire a large amount of point cloud data. With an increase in application demand, the processing of massive 3D point cloud data is constrained by storage space and transmission bandwidth.

For example, a point cloud video has a frame rate of 30 frames per second (fps). The number (quantity) of points in each frame of point cloud is 700 thousand. Each point has coordinate information xyz (float) and colour information RGB (uchar). In this case, a 10 s point cloud video has a data volume of approximately 3.15 GB (0.7 million×(4 Byte×3+1 Byte×3)×30 fps×10 s=3.15 GB), where 1 Byte corresponds to 10 bit. For a 1280×720 two-dimensional video with a YUV sampling format of 4:2:0 and a frame rate of 30 fps, the data volume of the 10 s video is approximately 0.39 GB (1280×720×12 bit×30 frames×10 s≈0.39 GB). A 10 s two-view 3D video has a data volume of approximately 0.78 GB (0.39×2=0.78 GB). As can be seen, the data volume of the point cloud video is much greater than the data volume of the two-dimensional video and the data volume of the 3D video with the same duration. Therefore, in order to better achieve data management, save storage space of a server, and reduce transmission traffic and transmission time between the server and a client, point cloud compression has become a key issue to promote the development of point cloud industry.

That is to say, since the point cloud is a collection of massive amounts of points, storing the point cloud not only consumes a lot of memory, but is not conducive to transmission. Also, there is no such large bandwidth available to support the transmission of the point cloud directly across the network layer without compression. Therefore, the point cloud needs to be compressed.

Currently, a point cloud coding framework that can compress the point cloud may be a geometry-based point cloud compression (G-PCC) coding framework or a video-based point cloud compression (V-PCC) coding framework provided by the moving picture experts group (MPEG), or may be the audio video standard (AVS)-PCC coding framework provided by the AVS. The G-PCC coding framework may be used for compression of the first-type static point cloud and the third-type dynamically-obtained point cloud, which may be based on test model compression 13 (TMC13). The V-PCC coding framework may be used for compression of the second-type dynamic point cloud, which may be based on test model compression 2 (TMC2). Therefore, the G-PCC coding framework is also known as the point cloud codec TMC13, and the V-PCC coding framework is also known as the point cloud codec TMC2.

A network architecture of a point cloud coding system including a decoding method and an encoding method is provided in embodiments of the disclosure. FIG. 3 is a schematic diagram of a network architecture of point cloud coding provided in embodiments of the disclosure. As illustrated in FIG. 3, the network architecture includes one or more electronic devices 13 to 1N and a communication network 01. The electronic devices 13 to 1N can perform video interaction through the communication network 01. The electronic device may be various types of devices having video coding functions during implementation. For example, the electronic device may include a mobile phone, a tablet computer, a personal computer, a personal digital assistant, a navigator, a digital phone, a video phone, a television, a sensing device, a server, etc., which is not limited in embodiments of the disclosure. The decoder or the encoder in embodiments of the disclosure may be the electronic device.

The electronic devices in embodiments of the disclosure have a point cloud coding function, and generally include a point cloud encoder (namely, an encoder) and a point cloud decoder (namely, a decoder).

The following will describe the related art by taking the G-PCC coding framework and AVS coding framework as an example.

It may be understood that, in a point cloud G-PCC coding framework, point cloud data to-be-encoded is first partitioned into multiple slices through slice partitioning. In each slice, geometry information of the point cloud and attribute information corresponding to each point are encoded separately.

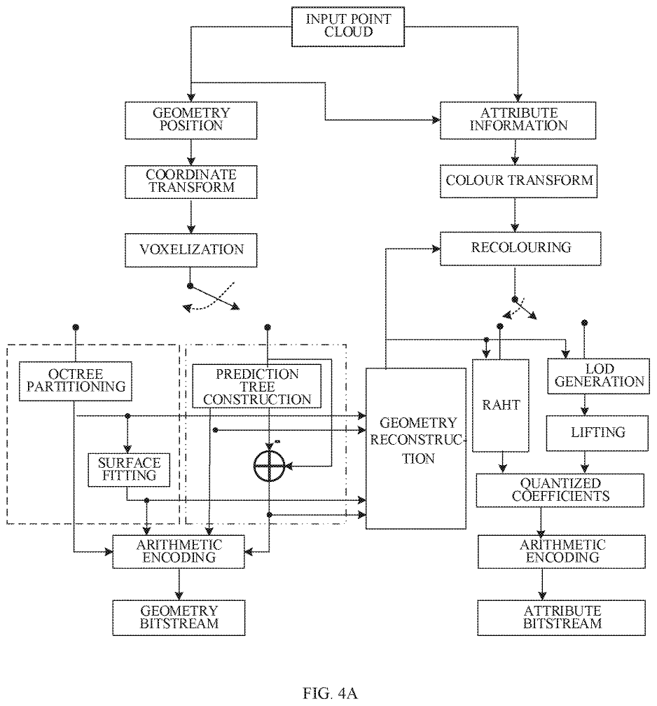

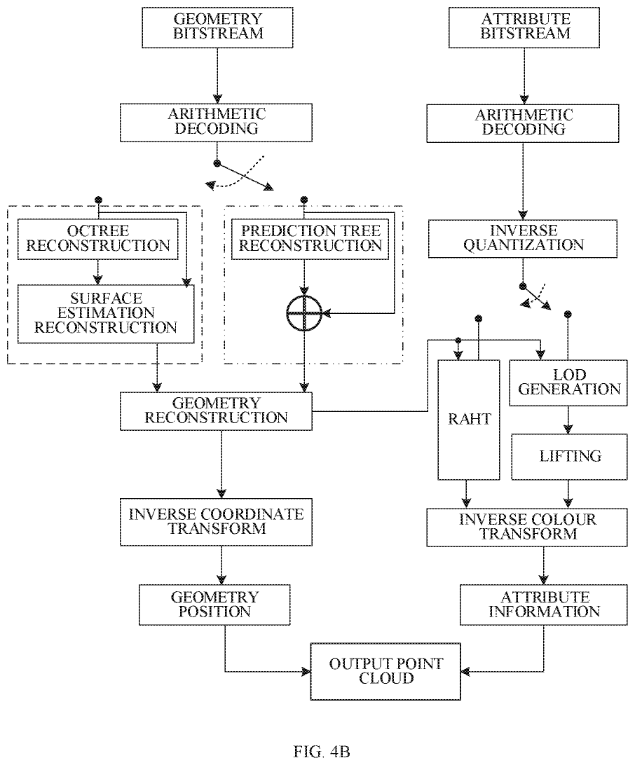

FIG. 4A is a schematic diagram of a framework of a G-PCC encoder. As illustrated in FIG. 4A, during geometry encoding, coordinate transform is performed on geometry information, so that the whole point cloud is contained in a bounding box. This is followed by quantization, which is mainly a scaling process. Due to rounding in the quantization, the geometry information of part of the point cloud is the same, and thus whether to remove duplicate points is determined based on parameters. The process of quantization and removal of the duplicate points is also referred to as voxelization. Next, octree partitioning or prediction tree construction is performed on the bounding box. In this process, arithmetic encoding is performed on points in leaf nodes obtained through partitioning, to generate a binary geometry bitstream, or arithmetic encoding (surface fitting based on vertices) is performed on vertices generated through partitioning, to generate a binary geometry bitstream. During attribute encoding, after the geometry encoding is completed and the geometry information is reconstructed, colour transform needs to be performed first, and colour information (namely, attribute information) is transformed from RGB colour space to YUV colour space. Then, the reconstructed geometry information is used to recolour the point cloud, so that the uncoded attribute information can correspond to the reconstructed geometry information. The attribute encoding is mainly performed on colour information. During encoding of the colour information, there are mainly three transform methods. The first two methods rely on level of detail (LOD) partitioning, which are distance-based lifting transform and predicting transform respectively. The third method is direct region adaptive hierarchical transform (RAHT). All the three methods make the colour information be transformed from the spatial domain to the frequency domain, to obtain a high-frequency coefficient and a low-frequency coefficient through transform. Finally, the coefficients are quantized, and then arithmetic encoding is performed on quantized coefficients to generate a binary attribute bitstream.

FIG. 4B is a schematic diagram of a framework of a G-PCC decoder. As illustrated in FIG. 4B, for an obtained binary bitstream, a geometry bitstream and an attribute bitstream in the binary bitstream are first decoded separately. During decoding of the geometry bitstream, geometry information of the point cloud is obtained through arithmetic decoding-octree reconstruction/prediction tree reconstruction-geometry reconstruction-inverse coordinate transform. During decoding of the attribute bitstream, attribute information of the point cloud is obtained through arithmetic decoding-inverse quantization-LOD partitioning/RAHT-inverse colour transform. Point cloud data to-be-encoded (i.e., output point cloud) is restored based on the geometry information and the attribute information.

It may be noted that as illustrated in FIG. 4A and FIG. 4B, currently, the G-PCC geometry coding may be octree geometry coding (indicated by a dashed box) or predictive geometry coding (indicated by a dash-dotted box).

The octree geometry encoding (OctGeomEnc) includes the following operations. First, coordinate transform is performed on geometry information, so that the whole point cloud is contained in a bounding box. This is followed by quantization, which is mainly a scaling process. Due to rounding in the quantization, some points have the same geometry information. Whether to remove duplicate points is determined based on parameters. The process of quantization and removal of the duplicate points is also referred to as voxelization. Next, tree (for example, octree, quadtree, and binary tree) partitioning is continuously performed on the bounding box in the order of breadth-first search, and an occupancy code of each node is encoded. In the related art, some company has proposed an implicit geometry partitioning method. First, a bounding box (2^{d}^{ₓ}, 2^{d}^{_{y}}, 2^{d}^{_{z}}) of the point cloud is calculated. It is assumed that dₓ>d_{y}>d_{z}, and this bounding box corresponds to a rectangular cuboid. During geometry partitioning, first, binary tree partitioning proceeds based on the x-axis to obtain two child nodes. Then, quadtree partitioning proceeds based on the x and y axes only when a condition dₓ=d_{y}>d_{z} is satisfied, to obtain four child nodes. Finally, when a condition dₓ=d_{y}=d_{z} is satisfied, octree partitioning proceeds until a resulting leaf node is 1×1×1 unit cube. Points in the leaf node are encoded to generate a binary bitstream. During binary tree/quadtree/octree-based partitioning, two parameters K and M are introduced. Parameter K indicates the maximum number of binary tree/quadtree partitions before octree partitioning. Parameter M indicates that a side length of a corresponding minimum block is 2^{M} during binary tree/quadtree partitioning. In addition, K and M need to satisfy the following conditions: assuming dₘₐₓ=max(dₓ,d_{y},d_{z}) and dₘᵢₙ=min(dₓ,d_{y},d_{z}), parameter K satisfies K≥dₘₐₓ−dₘᵢₙ, and parameter M satisfies M≥dₘᵢₙ. The reason why parameters K and M satisfy the above conditions is that during implicit geometry partitioning for G-PCC, the priority of the partitioning method is currently a binary tree, a quadtree, and an octree. Octree partitioning is continuously performed on a node only when the size of a node block does not satisfy conditions for the binary tree/quadtree, until a resulting leaf node reaches the minimum unit of 1×1×1. In an octree-based geometry information encoding mode, correlation between neighbouring points in space can be used for effectively encoding geometry information of the point cloud, and for some relatively flat nodes or nodes with planar characteristics, the encoding performance of the geometry information of the point cloud can be further improved through planar coding.

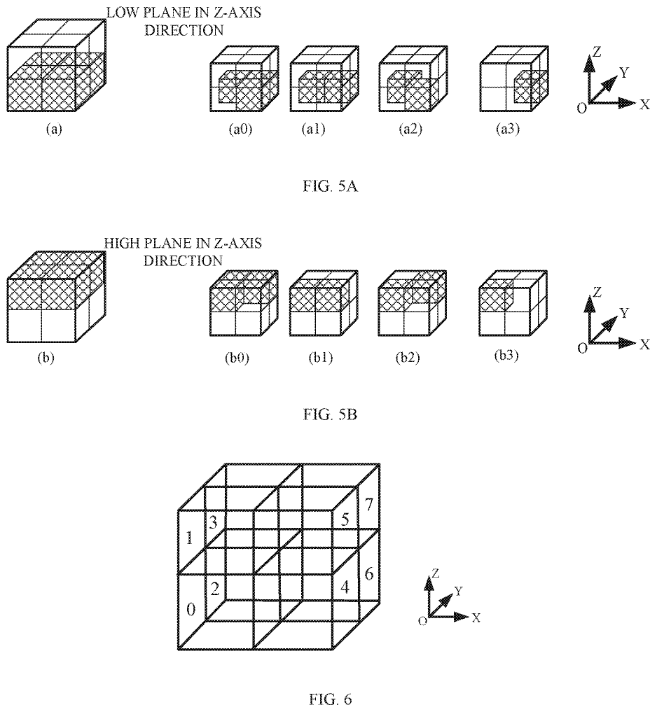

Exemplarily, FIG. 5A and FIG. 5B provide schematic diagrams illustrating plane positions, FIG. 5A is a schematic diagram illustrating low plane positions in a Z-axis direction, and FIG. 5B is a schematic diagram illustrating high plane positions in a Z-axis direction. As illustrated in FIG. 5A, (a), (a0), (a1), (a2), and (a3) herein all belong to the low plane positions in the Z-axis direction. Taking (a) as an example, it can be seen that four occupied child nodes in a current node are all located at low plane positions of the current node in the Z-axis direction, and in this case, it can be considered that the current node belongs to a Z-plane and is at a low plane in the Z-axis direction. Similarly, as illustrated in FIG. 5B, (b), (b0), (b1), (b2), and (b3) herein all belong to the high plane positions in the Z-axis direction. Taking (b) as an example, it can be seen that four occupied child nodes in a current node are located at high plane positions of the current node in the Z-axis direction, and in this case, it can be considered that the current node belongs to a Z-plane and is at a high plane in the Z-axis direction.

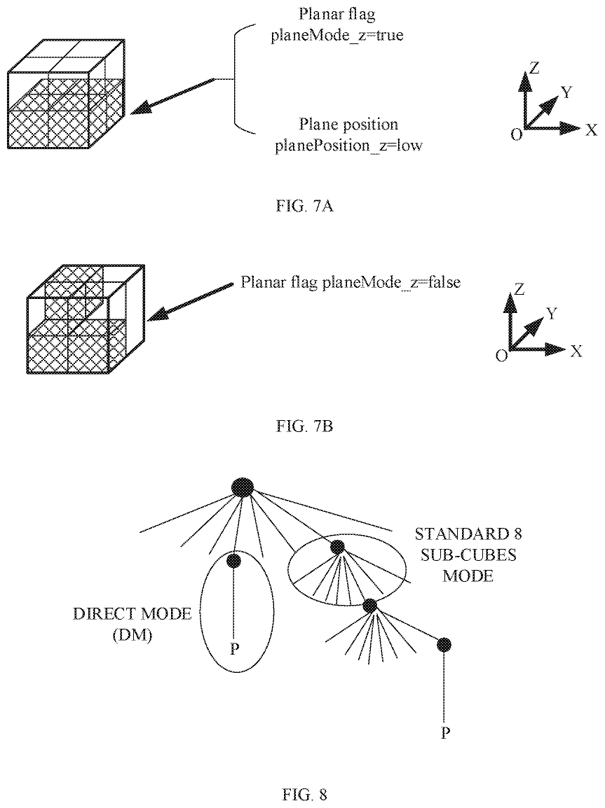

Further, taking (a) in FIG. 5A as an example, the performance of octree coding and the performance of planar coding are compared. FIG. 6 provides a schematic diagram of a node encoding order, that is, node encoding is performed in the order of 0, 1, 2, 3, 4, 5, 6, and 7 illustrated in FIG. 6. Herein, if an octree coding mode is used for (a) in FIG. 5A, occupancy information of the current node is represented by 10101010. However, if a planar coding mode is used, a flag needs to be first encoded to indicate that the current node is planar in the Z-axis direction. Then, if the current node is planar in the Z-axis direction, a plane position of the current node also needs to be indicated. Next, only occupancy information of nodes at the low plane in the Z-axis direction (i.e., occupancy information of four child nodes 0, 2, 4, and 6) needs to be encoded. Therefore, for encoding the current node based on the planar coding mode, only six bits need to be encoded, and compared with octree coding in the related art, two bits can be reduced. Based on this analysis, the coding performance is more significant in planar coding compared with octree coding. Therefore, in a certain dimension, if an occupied node is encoded using the planar coding mode, planar flag information (planarMode) and plane position (PlanePos) information of the current node in this dimension need to be first indicated, and then occupancy information of the current node is encoded based on planar information of the current node. Exemplarily, FIG. 7A is a schematic diagram of planar flag information. As illustrated in FIG. 7A, it indicates a low plane in a Z-axis direction; and correspondingly, a value of the planar flag information is true or 1, i.e., planarMode__{Z}=true, and plane position information indicates low, i.e., PlanePosition__{Z}=low. FIG. 7B is another schematic diagram of planar flag information. As illustrated in FIG. 7B, it is not planar in a Z-axis direction; and correspondingly, a value of the planar flag information is false or 0, i.e., planarMode__{Z}=false.

It may be noted that, for PlaneMode_ᵢ, 0 indicates that the current node is not planar in an i-axis direction, and 1 indicates that the current node is planar in the i-axis direction. If the current node is planar in the i-axis direction, then for PlanePosition_ᵢ, 0 indicates that the current node is planar in the i-axis direction and a plane position is low, and 1 indicates that the current node is at a high plane in the i-axis direction. Herein, i represents a coordinate dimension and may be an X-axis direction, a Y-axis direction, or a Z-axis direction, and thus i=0, 1, 2.

In an octree-based geometry information encoding mode, an efficient compression rate is achieved for only points with correlation in space, and for points at isolated positions in geometric space, complexity can be greatly reduced by using a direct coding mode (DCM). For all nodes in the octree, instead of being indicated by a flag, the usage of the DCM is inferred from information of a neighbour(s) and a parent node of a current node. There are three methods for determining whether the current node has eligibility for DCM coding. Details are as follows.
(1) The current node has no sibling child node, that is, the parent node of the current node has only one child node. In addition, a parent node of the parent node of the current node has only two occupied child nodes, that is, the current node has at most one neighbouring node.
(2) The parent node of the current node has only one occupied child node, i.e., the current node. In addition, six neighbouring nodes sharing a face with the current node all belong to empty nodes.
(3) The number of sibling nodes of the current node is greater than 1.

Exemplarily, FIG. 8 provides a schematic diagram illustrating IDCM coding. If the current node does not have eligibility for DCM coding, octree partitioning will be performed on the current node. If the current node has eligibility for DCM coding, the number of points contained in the current node will be further determined. If the number of points is less than a threshold (for example, 2), DCM coding is performed on the current node, and otherwise, octree partitioning is continued. For using a DCM coding mode, whether the current node is a real isolated point, i.e., IDCM_flag, needs to be first encoded. If IDCM_flag is true, DCM coding is applied for the current node, and otherwise, octree coding is still applied for the current node. When the current node is eligible for DCM coding, the DCM coding mode for the current node needs to be encoded. Currently, there are two DCM modes: (a) there is only one point (or multiple points which, however, belong to duplicate points); and (b) two points are contained. Finally, geometry information of each point needs to be encoded. Assuming that a side length of a node is 2^{d}, d bits are needed for encoding each component of geometry coordinates of the node, and information of these bits is directly signalled in a bitstream. Herein, it may be noted that for coding of the lidar point cloud, the collection parameter of the lidar is used for predictive coding of coordinate information in three dimensions, thereby further improving the coding performance of geometry information.

It may be noted that, when a node is partitioned into a leaf node, in case of lossless geometry encoding, the number of duplicate points in the leaf node needs to be encoded. Finally, occupancy information of all nodes is encoded to generate a binary bitstream. In addition, a planar coding mode is currently introduced in G-PCC. During geometry partitioning, whether child nodes of the current node are located at the same plane is determined. If the child nodes of the current node are at the same plane, the child nodes of the current node may be represented by this plane.

For the octree geometry decoding, before decoding occupancy information of each node in the order of breadth-first search, the decoding end first determines, based on reconstructed geometry information, whether planar decoding or IDCM decoding is performed on the current node. If the current node satisfies a condition for planar decoding, the decoding end first decodes planar flag information and plane position information of the current node, and then decodes occupancy information of the current node based on planar information. If the current node satisfies a condition for IDCM decoding, the decoding end first decodes whether the current node is a real IDCM node. If the current node is a real IDCM node, the decoding end further parses a DCM decoding mode for the current node, then obtains the number of points in a current DCM node, and finally decodes geometry information of each point. For a node that is eligible for neither planar decoding nor DCM decoding, occupancy information of the current node is decoded. An occupancy code of each node is obtained through continuous parsing in such a manner, and the node is sequentially partitioned until a 1×1×1 unit cube is obtained. The number of points contained in each leaf node is parsed out, and finally geometry-reconstructed point cloud information is restored.

For triangle soup (trisoup)-based geometry information encoding, geometry partitioning is also performed first in a trisoup-based geometry information encoding framework. However, different from binary tree/quadtree/octree-based geometry information encoding, in this method, instead of partitioning the point cloud layer-by-layer into 1×1×1 unit cubes, the partitioning is stopped when the side length of a block is W. Based on a surface formed by distribution of the point cloud in each block, up to 12 vertices generated between the 12 edges of the block and the surface are obtained. Then, coordinates of the vertices of each block are encoded in sequence and thus the binary bitstream is generated.

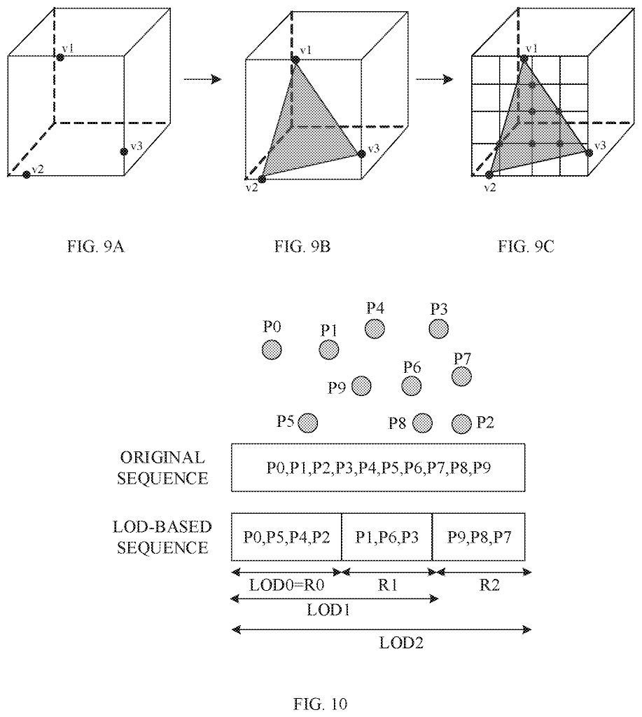

For trisoup-based point cloud geometry information reconstruction, during point cloud geometry information reconstruction at the decoding end, the decoding end first decodes vertex coordinates to complete trisoup reconstruction. This process is illustrated in FIG. 9A, FIG. 9B, and FIG. 9C. There are three vertices (v1, v2, v3) in a block illustrated in FIG. 9A. A structure formed by these three vertices in a certain order is called a triangle soup, i.e., trisoup, as illustrated in FIG. 9B. Then, sampling is performed on the trisoup, and an obtained sampling point(s) is determined as a reconstructed point cloud in the block, as illustrated in FIG. 9C.

The predictive geometry encoding (PredGeomTree) includes the following operations. First, ordering is performed on an input point cloud. Ordering methods currently used include disordering, Morton ordering, azimuth ordering, and radial distance ordering. At the encoding end, a prediction tree structure is built in two different modes: high-latency slow mode (KD-Tree) and low-latency fast mode (using lidar calibration information). By using the lidar calibration information, each point is assigned to a different laser, and the prediction tree structure is built according to the different laser. Next, based on the prediction tree structure, by traversing each node in the prediction tree, geometry position information of the node is predicted by selecting a different prediction mode to obtain a prediction residual, and the geometry prediction residual is quantized by using a quantization parameter. Finally, the prediction residual of the position information of the prediction tree node, the prediction tree structure, the quantization parameter, and the like are encoded through continuous iteration, to generate a binary bitstream.

For predictive geometry decoding, the decoding end reconstructs a prediction tree structure by continuously parsing a bitstream. Then, the decoding end obtains prediction residual information of a geometry position of each prediction node and a quantization parameter through parsing, and performs inverse quantization on the prediction residual to restore reconstructed geometry position information of each node. Finally, geometry reconstruction at the decoding end is completed.

After completion of geometry encoding, geometry information needs to be reconstructed. Currently, attribute encoding is mainly performed on colour information. First, the colour information is transformed from RGB colour space to YUV colour space. Then, the reconstructed geometry information is used to recolour the point cloud, so that the uncoded attribute information can correspond to the reconstructed geometry information. During encoding of the colour information, there are mainly two transform methods. One is distance-based lifting transform which relies on LOD partitioning, and the other is direct RAHT, both of which transform the colour information from the spatial domain to the frequency domain to obtain high-frequency coefficients and low-frequency coefficients through transform, and finally quantize and encode the coefficients to generate a binary bitstream. For details, reference can be made to FIG. 4A and FIG. 4B.

Further, during prediction of attribute information based on the geometry information, Morton codes can be used for nearest-neighbour search, and a Morton code corresponding to each point in the point cloud can be obtained from geometry coordinates of the point. A specific method for calculating the Morton code will be described below. For 3D coordinates with each component represented by a d-bit binary digit, three components may be represented as follows.

$$x = {\sum }_{1 = 1}^{d} {2}^{d - 1} {x}_{1} , y = {\sum }_{1 = 1}^{d} {2}^{d - 1} {y}_{1} , z = {\sum }_{1 = 1}^{d} {2}^{d - 1} {z}_{1} \qquad ( 1 )$$

xₗ,yₗ,zₗ∈{0,1} are respectively corresponding binary values from the most significant bit (l=1) to the least significant bit (l=d) of x, y, z. The Morton code M is obtained by interleaving xₗ,yₗ,zₗ from the most significant bit to the least significant bit for x, y, z. The calculation formula of M is as follows.

$$M = {\sum }_{1 = 1}^{d} {2}^{3 ( d - 1 )} ( 4 {x}_{1} + 2 {y}_{1} + {z}_{1} ) = {\sum }_{{1}^{′} = 1}^{3 d} {2}^{3 d - {1}^{′}} {m}_{{1}^{′}} \qquad ( 2 )$$

m_{l′}∈{0,1} are respectively values from the most significant bit (1=1) to the least significant bit (l=3d) of M. After the Morton code M of each point in the point cloud is obtained, the points in the point cloud are ordered in an ascending order of the Morton codes, and a weight w of each point is set to 1.

As mentioned above, for encoding of the attribute information, there are mainly three transform methods: lifting transform, predicting transform, and RAHT transform. In the lifting transform and predicting transform, prediction and transform are performed on the point cloud based on the order of LOD generation, and in the RAHT transform, adaptive transform is performed on the attribute information from the bottom to the top based on a hierarchy of octree construction. Next, these three methods for transform coding will be described. A method for prediction transform coding will be first described in detail below.

Currently, an attribute prediction module in G-PCC uses a nearest-neighbour attribute prediction coding scheme based on an LOD structure. A method for LOD construction includes a distance-based LOD construction scheme, a fixed sampling rate-based LOD construction scheme, an octree-based LOD construction scheme, and the like. In the distance-based LOD construction scheme, before LOD construction, Morton ordering is first performed on the point cloud to ensure strong attribute correlation between neighbouring points. FIG. 10 is a schematic diagram illustrating distance-based LOD construction. As illustrated in FIG. 10, according to L Manhattan distances (dl)l=0, 1, . . . , L−1 preset, point clouds are partitioned into L different refinement levels (Rl)l=0, 1, . . . , L−1. Herein, (dl)l=0, 1, . . . , L−1 satisfies dl<dl−1.

The LOD construction is described as follows. (1) First, all points in the point cloud are labelled as non-visited, and a set Vis established to store a set of visited points. (2) During each iteration 1, the points in the point cloud are traversed. If a current point has been visited, the current point is ignored. Otherwise, the minimum distance D of the current point to the set V of points is calculated. If D<dl, the current point is ignored. If D≥dl, the current point is labelled as visited and added to the refinement level Rl and the set V of points. (3) Points in the level of detail LOD/include points in refinement levels R0, R1, R2 . . . Rl. (4) The above operations are repeated until all the points are labelled as visited.

Based on the LOD structure, reconstructed attribute information of a point in the same or higher LOD layer is used for linear weighted prediction on attribute information of each point. The maximum number of reference prediction neighbouring points is determined by a high-level syntax element in the encoder. For an attribute of each point, at the encoding end, based on a rate-distortion optimization (RDO) algorithm, attribute information of N nearest neighbouring points found are selected for weighted prediction, or attribute information of a single nearest neighbouring point is selected for prediction. Finally, a selected prediction mode and prediction residual are encoded. In the LOD structure, a formula for prediction of attribute information of the current point may be as follows.

$${Attr}_{i}^{′} = Round ( \frac{1}{N} {\sum }_{m ∈ {p}_{i}} \frac{\frac{1}{{D}_{m}^{2}}}{{\sum }_{m ∈ p} \frac{1}{{D}_{m}^{2}}} {Attr}_{m} ) \qquad ( 3 )$$

N represents the number of prediction points in a set of nearest neighbouring points of current point i, Pᵢ represents the sum of N nearest neighbouring points of current point i, Dₘ represents a spatial geometry distance between nearest neighbouring point m and current point i, Attrₘ represents reconstructed attribute information of nearest neighbouring point m, Attrᵢ′ represents attribute prediction information of current point i, and the number N of points is a preset value.

To keep tradeoff of attribute coding performance and parallel processing between different LOD layers, a switch may be introduced in a high-level syntax element in the encoder. The switch may control whether to introduce intra LOD prediction. For example, if the switch is switched on, intra LOD prediction is enabled, and thus points in the same LOD layer may be used for prediction. It may be noted that, intra LOD prediction is always applied when the number of LOD layers is 1,

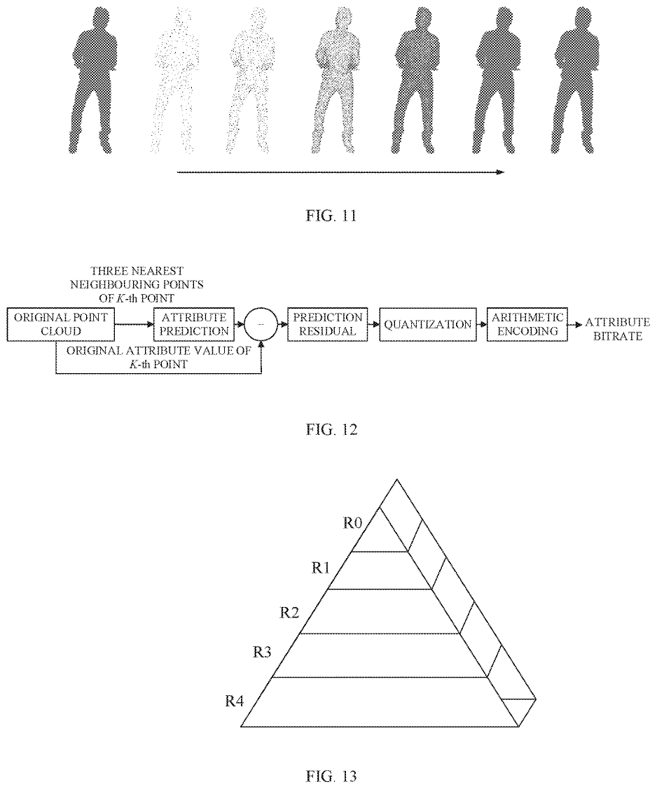

FIG. 11 is a schematic diagram illustrating generation of a distance-based LOD point cloud. As illustrated in FIG. 11, the first picture on the left is an original point cloud, the second picture on the left represents an outer contour of the point cloud, and in the following pictures, as the number of LODs gradually increases, details of the point cloud gradually become clear. The prediction of attribute information of the LOD-structured point cloud will be described in detail below.

FIG. 12 is a schematic diagram illustrating encoding of attribute information of an LOD point cloud. After LOD construction is completed, according to the order of LOD generation, three nearest neighbouring points of a current point to-be-encoded are first found from encoded data points. Reconstructed attribute values of these three nearest neighbouring points are determined as candidate prediction values of the current point to-be-encoded. Then, an optimal prediction value is selected therefrom according to an RDO algorithm. For example, as illustrated in table 1, during encoding of an attribute value of point P2 in FIG. 10, a predictor index of an attribute value of first-nearest neighbouring point P4 may be set to 1, an attribute predictor index of second-nearest neighbouring point P5 and an attribute predictor index of third-nearest neighbouring point P0 are set to 2 and 3 respectively, and a predictor index of a weighted average value of points P0, P5, and P4 is set to 0. Finally, an optimal predictor is selected according to the RDO algorithm. A formula for weighted averaging is as follows.

$${\hat{a}}_{i} = Round ( {\sum }_{j = 0}^{2} \frac{{\tilde{w}}_{ij}}{{\sum }_{j = 0}^{2} {\tilde{w}}_{ij}} {\tilde{a}}_{ij} ) \qquad ( 4 )$$

In the formula, \tilde{w}ᵢⱼ represents a spatial geometry weight from a nearest neighbouring point j to the current point i.

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}} \qquad ( 5 )$$

âᵢ represents an attribute prediction value of the current point i,j represents indexes of three neighbouring points, ay represents a reconstructed attribute value of the nearest neighbouring point, xᵢ,yᵢ,zᵢ represent geometry position coordinates of the current point i, and xᵢⱼ,yᵢⱼ,zᵢⱼ represent geometry coordinates of the nearest neighbouring point j.

TABLE 1

| Prediction mode | Prediction value |
|---|---|
| 0 | Weighted average of attributes |
| | of three nearest neighbours |
| 1 | P4 (attribute value of first- |
| | nearest neighbour) |
| 2 | P5 (attribute value of second- |
| | nearest neighbour) |
| 3 | P0 (attribute value of third- |
| | nearest neighbour) |

The attribute prediction value (âᵢ)_{i∈0 . . . k-1} (where k is the total point number of the point cloud) of the current point i is obtained through the above prediction. Assuming that (aᵢ)_{i∈0 . . . k-1} is an original attribute value of the current point, an attribute residual (rᵢ)_{i∈0 . . . k-1} is denoted as:

r=aᵢ−âᵢ (6)

Further, a prediction residual is quantized:

$${Q}_{i} = \frac{{r}_{i}}{Qs} \qquad ( 7 )$$

In formula (7), Qᵢ represents a quantized attribute residual of the current point i. Qs is a quantization step (Qs), which can be calculated from a quantization parameter (QP). After quantization, arithmetic encoding is performed on quantized coefficients, and finally an attribute bitrate is generated.

During encoding, the encoding end reconstructs an attribute value of the current point i. The purpose of reconstruction is for prediction of a subsequent point(s). Before reconstruction of the attribute value, inverse quantization needs to be performed on a residual. \hat{r}ᵢ is denoted as an inverse-quantized residual:

\hat{r}ᵢ=Qᵢ×Qs (8)

A reconstructed value a, of the point i is obtained by adding j and the prediction value âᵢ.

ãᵢ=\hat{r}ᵢ+âᵢ (9)

As can be seen from the above description, based on LOD partitioning, nearest-neighbour search is needed for prediction of the attribute value of the current point. There are currently two main categories of manners of nearest-neighbour search: intra nearest-neighbour search and inter nearest-neighbour search. These two manners of nearest-neighbour search will be described in detail below.

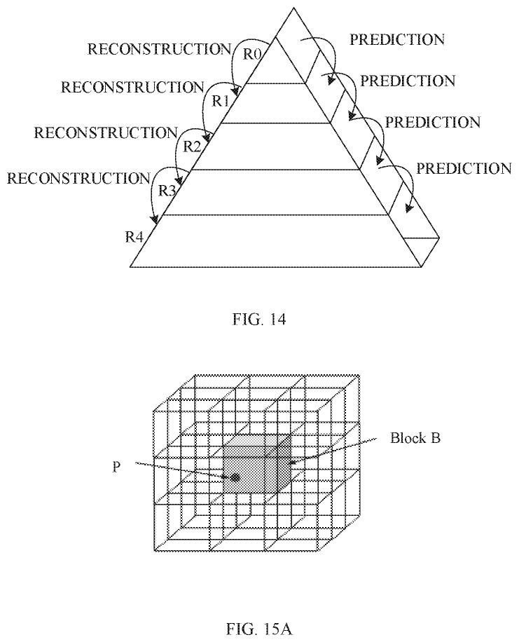

For intra nearest-neighbour search, there may be two manners: inter-layer nearest-neighbour search and intra-layer nearest-neighbour search. First, the inter-layer nearest-neighbour search will be described. FIG. 13 is a schematic structural diagram illustrating refinement levels based on LOD partitioning. As illustrated in FIG. 13, after LOD partitioning, different refinement levels R form a pyramid-like structure. The manner of inter-layer nearest-neighbour search may be illustrated in FIG. 14. Based on the manner illustrated in FIG. 10, different LOD layers LOD0, LOD1, and LOD2, are first obtained through partitioning of geometry information. A point in LOD0 is used for prediction of an attribute of a point in a next LOD layer during inter-layer nearest-neighbour search. Next, the process of inter-layer nearest-neighbour search will be described in detail below.

In the whole LOD partitioning process, there are three sets: O(k), L(k), and I(k). Herein, k is an index of an LOD layer during LOD partitioning, and I(k) is an input point set during partitioning of a current LOD layer. After LOD partitioning, sets O(k) and L(k) are obtained. The set O(k) stores a set of sampling points, and L(k) is a set of points in the current LOD layer. That is, the whole LOD partitioning process is as follows.
(1) Initialization;
if k=0, L(k)←{ }. Otherwise, L(k)←L(k−1)
O(k)←{ }
(2) According to an LOD partitioning algorithm, sampling points are stored in O(k), and remaining points are partitioned into L(k).
(3) When the next iteration proceeds, I←O(k).

It may be noted herein that, since the whole LOD partitioning is performed based on Morton codes, Morton code indexes corresponding to points are stored in O(k), L(k), and I(k). During inter-layer nearest-neighbour search, i.e., nearest-neighbour search for points in the set L(k) in the set O(k), a specific search manner will be described in detail below.

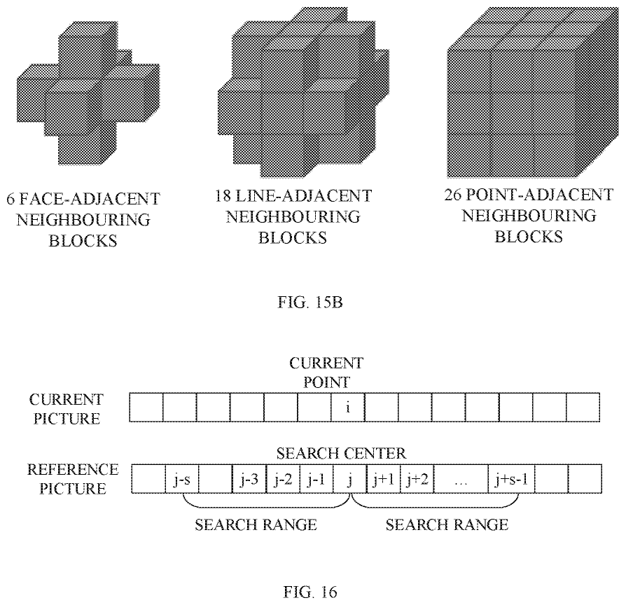

First, nearest-neighbour search is performed based on a spatial relationship. As illustrated in FIG. 15A, during prediction of current point P, a parent block (block B) corresponding to point P is used for neighbour search. FIG. 15B is a schematic diagram illustrating neighbouring blocks that are coplanar, collinear, or concurrent with a current parent block. As illustrated in FIG. 15B, points in a neighbouring block that is coplanar or collinear with the current parent block are searched for attribute prediction in FIG. 15B. That is to say, a corresponding spatial block is obtained based on coordinates of a current point. Then, N nearest neighbours of the current point are obtained through nearest-neighbour search for a spatial block that is coplanar, collinear, or concurrent with a current block in a previously-encoded LOD layer.

If the N nearest neighbours of the current point are still not obtained after the coplanar, collinear, or concurrent nearest-neighbour search, then next, the N nearest neighbours of the current point may be obtained based on a fast search algorithm. A specific manner may be illustrated in FIG. 16. FIG. 16 is a schematic diagram illustrating a manner of nearest-neighbour search for a current point. As illustrated in FIG. 16, during attribute inter-layer prediction, a Morton code of a current point may be obtained based on geometry coordinates of the current point. Then, the first reference point (j) with Morton code greater than the Morton code of the current point is found in a reference picture based on the Morton code of the current point, and nearest-neighbour search is performed within a range of [j−searchRange, j+searchRange]. A specific manner of updating a nearest neighbour is the same as a manner of inter nearest-neighbour search, which will be described during description of the inter nearest-neighbour search and will not be repeated herein. The intra-layer nearest-neighbour search will be described in detail below.

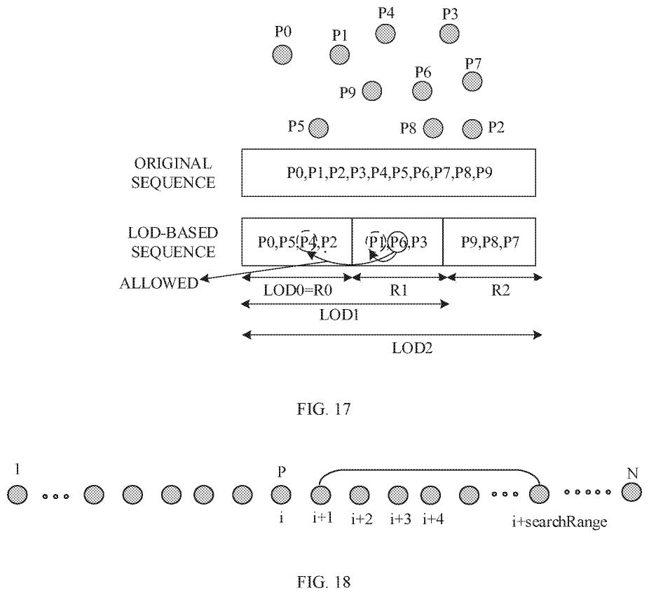

FIG. 17 is a schematic diagram illustrating a manner of intra-layer nearest-neighbour search for attribute information. As illustrated in FIG. 17, when a manner of intra-layer prediction is enabled, nearest-neighbour search is performed in a set of encoded points within the same LOD layer, to obtain N nearest neighbours of a current point (inter-layer nearest-neighbour search is also performed). Nearest-neighbour search may be performed based on fast search. For example, as illustrated in FIG. 18, assuming that a Morton code index of a current point is i, then nearest-neighbour search is performed in [i+1, i+searchRange]. A specific manner of nearest-neighbour search is the same as a manner of inter block-based fast search and will not be repeated herein. The manner of inter nearest-neighbour search will be described in detail below.

Further, as illustrated in FIG. 16, during attribute inter prediction, a Morton code of a current point is obtained based on geometry coordinates of the current point. Based on the Morton code of the current point, the first reference point (j) with Morton code greater than the Morton code of the current point is found in a reference picture. Next, nearest-neighbour search is performed within a range of [j−searchRange, j+searchRange].

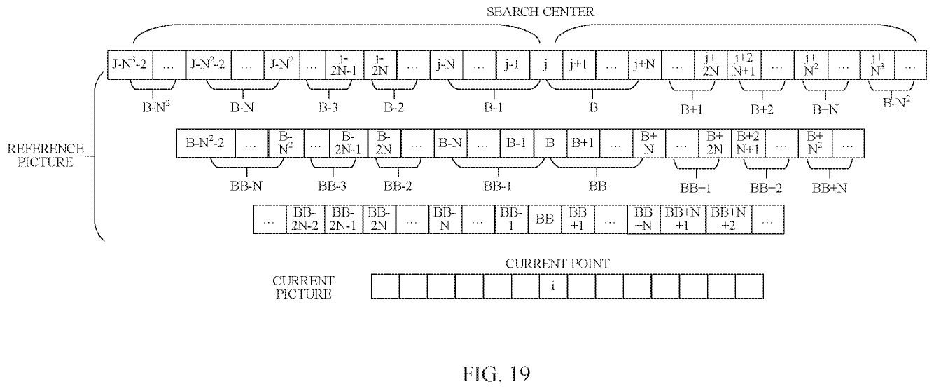

Currently, during intra and inter nearest-neighbour search, neighbourhood search is performed based on a block. FIG. 19 is a schematic diagram of a prediction structure for neighbourhood search based on Morton code. Exemplarily, as illustrated in FIG. 19, during neighbourhood search for a current point (with a Morton code index i), points in a reference picture are partitioned into N (N=3) layers according to Morton codes. A partitioning method may be as follows.

For the first layer, assuming that the number of points in the reference picture is numPoints, the points in the reference picture are first partitioned into one block every M (M=2⁵=32) points.

For the second layer, based on the first layer, blocks in the first layer are also partitioned into one block every M(M=2⁵=32) blocks in the order of Morton codes.

For the third layer, based on the second layer, blocks in the second layer are also partitioned into one block every M(M=2⁵=32) blocks in the order of Morton codes.

Finally, a prediction structure illustrated in FIG. 19 is obtained.

During attribute prediction based on the prediction structure illustrated in FIG. 19, assuming that a Morton code index of a current point to-be-encoded is i, the first point with Morton code greater than or equal to the Morton code of the current point is obtained in the reference picture, and an index of the first point is j. A block index of a reference point is calculated based on j. The specific calculation method is as follows.

For the first layer, BucketSize_0=2⁵=32.

For the second layer, BucketSize_1=2⁵=32×BucketSize_0=1024.

For the third layer, BucketSize_2=2⁵=32×BucketSize_1=32768.

Assuming that a reference range of a prediction picture of the current point is [j−searchRange, j+searchRange], a start index of the third layer is calculated based on j−searchRange, and an end index of the third layer is calculated based on j+searchRange. First, whether nearest-neighbour search is needed for some blocks in the second layer is first determined in blocks in the third layer. Then, whether the search is needed for each block in the first layer is determined. If nearest-neighbour search is needed for some blocks in the first layer, then point-by-point determination is performed on points in those blocks in the first layer to update a nearest neighbour(s). The following will describe a manner of index-based block calculation.

Assuming that a Morton code index of a current point is index, then an index of a corresponding block in the third layer is:

idx_2=index/BucketSize_2 (10)

After the index idx_2 of the block in the third layer is obtained, a start index and an end index of a block corresponding to a current block in the second layer can be obtained based on idx_2:

startIdx1=idx_2×BucketSize_1 (11)

endIdx=idx_2×BucketSize_1+BucketSize_1−1 (12)

Based on the same algorithm, an index of a block in the first layer is obtained according to an index of a block in the second layer.

During block-based nearest-neighbour search, whether nearest-neighbour search is needed for the current block is determined, that is, to filter blocks for nearest-neighbour search. Each spatial block can be obtained based on two variables minPos and maxPos, where minPos represents a minimum value of the block, and maxPos represents a maximum value of the block. It is assumed that a distance of the farthest point among N nearest neighbours found for the current point is Dist, coordinates of a point to-be-encoded are (x, y, z), and the current block is represented by (minPos, maxPos), where minPos is a minimum value of a bounding box in three dimensions, and maxPos is a maximum value of the bounding box in three dimensions. In this case, a distance D between the current point and the bounding box is calculated as follows:

int dx=int(std::max(std::max(minPos[0]−point[0],0),point[0]−maxPos[0])) (13)

int dy=int(std::max(std::max(minPos[1]−point[1],0),point[1]−maxPos[1])) (14)

int dz=int(std::max(std::max(minPos[2]−point[2],0),point[2]−maxPos[2])) (15)

D=dx+dy+dz (16)
where points in the current block are traversed only when D is less than or equal to Dist.

A method for prediction transform coding of the attribute information of the point cloud are described above. Next, a method for lifting transform coding of the attribute information of the point cloud will be described in detail below.

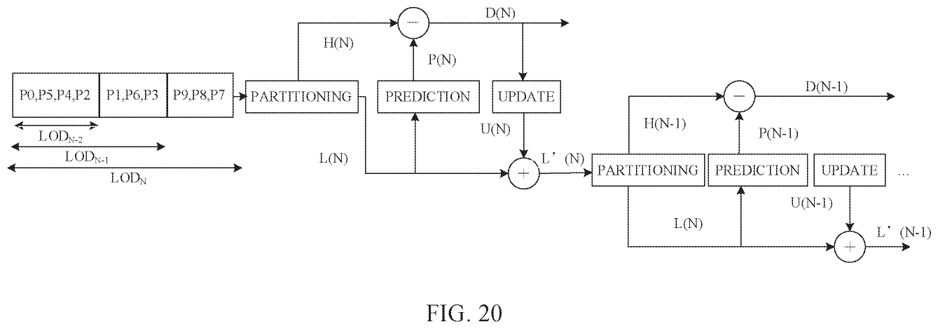

FIG. 20 is a schematic diagram illustrating a process of lifting transform coding. As illustrated in FIG. 20, lifting transform also refers to predictive coding of attributes of the point cloud based on LOD. Different from predicting transform described above, in lifting transform, LOD is partitioned into high and low layers. Then, prediction is performed in the reverse order of LOD generation layers, and an update operator is introduced in the prediction process to update quantization weights of points in the low LOD layer, thereby improving the accuracy of prediction. Since attribute values of the points in the low LOD layer are frequently used for prediction of attribute values of points in the high LOD layer, the points in the low LOD layer are more influential. Further, as illustrated in FIG. 20, a method for lifting transform coding may include three steps: a partitioning process, a prediction process, and an update process. Next, these three steps will be described in detail.

### Step 1, Partitioning Process

In the partitioning process, the complete LOD is partitioned into a low LOD layer(s) L(N) and a high LOD layer(s) H(N). If a point cloud has three LOD layers, that is, (LODₗ)_{l=0,1, 2′} then after partitioning, LOD₂ is the high LOD layer and denoted as H(N), and (LODₗ)_{l=0, 1} is the low LOD layer and denoted as L(N).

### Step 2, Prediction Process

For a point in the high LOD layer, attribute information of a nearest neighbouring point is selected from the low layer as an attribute prediction value P(N) of a current point to-be-encoded, and a prediction residual D(N) is denoted as:

D(N)=H(N)−P(N) (17)

### Step 3, Update Process

The attribute prediction residual D(N) of the high LOD layer is updated to obtain U(N), and an attribute value of a point in the low LOD layer is lifted based on U(N), as illustrated in the following formula:

L′(N)=L(N)+U(N) (18)

In the descending order of LODs, the above processes will be continuously iterated until the lowest LOD layer.

Since the LOD-based prediction scheme makes points in the low LOD layer more influential, a quantization weight is introduced in a transform method based on lifting wavelet transform, a prediction residual is updated based on the prediction residual D(N) and a distance between a prediction point and a neighbouring point, and finally the prediction residual is adaptively quantized by using a quantization weight during transform. It may be noted that, a quantization weight of each point may be determined through geometry reconstruction at the decoding end, and thus the quantization weight does not need to be encoded.

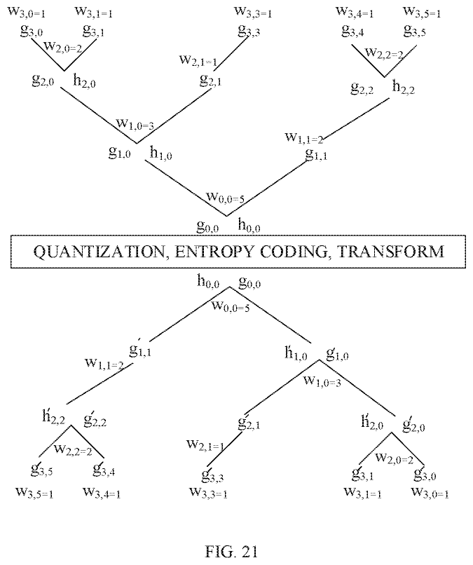

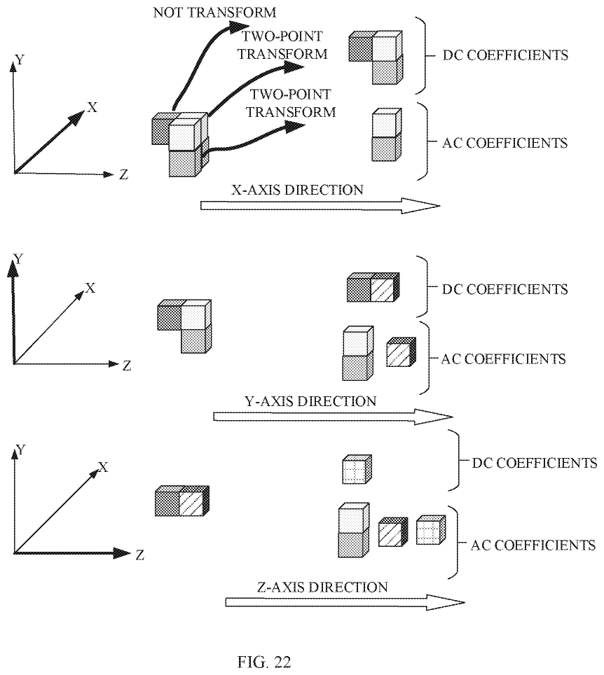

RAHT transform adopts a Haar wavelet transform in which attribute information of the point cloud may be transformed from the spatial domain to the frequency domain, thereby further reducing correlation between the attribute information of the point cloud. FIG. 21 is a diagram of an example of RAHT transform. As illustrated in FIG. 21, RAHT is to perform wavelet transform based on a hierarchical structure of an octree, so as to associate attribute information with octree nodes. Recursive transform is performed on attribute information of an occupied node(s) in the same parent node in a bottom-up manner, and transform is performed on nodes in each layer in X, Y, and Z dimensions (as illustrated in FIG. 22) until the root node of the octree is reached. During hierarchical transform, direct current (DC) coefficients (or referred to as low-pass coefficients) obtained after transform of nodes in the same layer are transmitted to nodes in the previous layer for further transform, and all alternating current (AC) coefficients (or referred to as high-pass coefficients) are quantized and encoded.

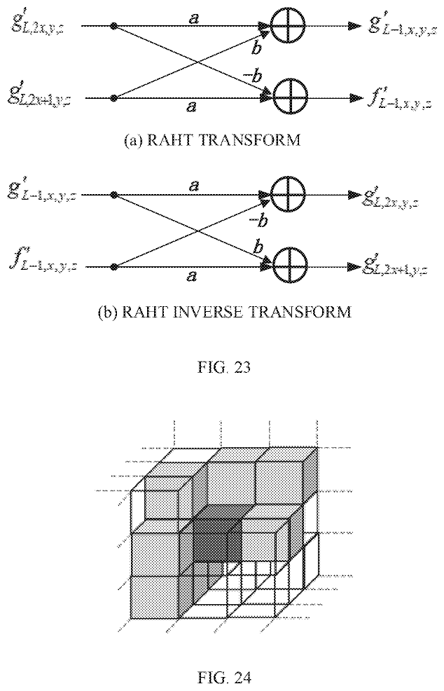

FIG. 23 is a schematic diagram illustrating RAHT transform and RAHT inverse transform. It is assumed that

$${g}_{L , 2 x , y , z}^{′} and {g}_{L , 2 x + 1 , y , z}^{′}$$

are DC coefficients of two neighbouring points in layer L. After RAHT transform, information of layer L−1 includes an AC coefficient

$${{f}^{′}}_{L - 1 , x , y , z}$$

and a DC coefficient

$${g}_{L , 1 , x , y , z}^{′} \cdot {f}_{L - 1 , x , y , z}^{′}$$

is no longer transformed and is directly quantized and encoded. For

$${g}_{L , 1 , x , y , z}^{′} ,$$

a neighbouring point continues to be searched for the transform. If no neighbouring point is found,

$${g}_{L , 1 , x , y , z}^{′}$$

may be directly transmitted to layer L−2. That is to say, RAHT transform is valid for only nodes with neighbouring points, and nodes without neighbouring points will be directly transmitted to the previous layer. In the above transform process, if weights (which may be determined based on the number of non-empty child nodes in the node) corresponding to

$${g}_{L , 2 x , y , z}^{′} and {g}_{L , 2 x + 2 , y , z}^{′}$$

are respectively

$${w}_{L , 2 x , y , z}^{′}$$

and

$${w}_{L , 2 x + 1 , y , z}^{′}$$

(respectively abbreviated as

$${w}_{0}^{′} and {w}_{1}^{′}$$

and a weight corresponding to

$${g}_{L - 1 , x , y , z}^{′}$$

is

$${w}_{L - 1 , x , y , z}^{′} ,$$

then a general transform formula for RAHT transform is:

$$[ \begin{matrix}{g}_{L ‐ 1 , x , y , z}^{′} \\ {{f}^{′}}_{L ‐ 1 , x , y , z}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] \qquad ( 19 )$$

In formula (19), T_{w0,w1} is a transform matrix. The transform matrix may be determined based on formula (20).

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ] \qquad ( 20 )$$

The transform matrix is adaptively updated as a weight corresponding to each point is transformed. The above transform process is iteratively updated according to a partitioning structure of an octree until the root node of the octree is reached.

Based on RAHT transform, RAHT intra prediction may be performed on attribute information, i.e., RAHT intra prediction combined transform coding may be performed on the attribute information. This coding mode will be described in detail below.

As illustrated in FIG. 24, RAHT transform is based on a hierarchical order of an octree, and the transform proceeds from the voxel level until a root node is obtained, thereby completing hierarchical transform coding of the whole attribute information. In RAHT intra prediction combined transform coding, prediction combined transform coding may also be performed on the attribute information based on the hierarchical order of the octree. The difference is that the RAHT intra prediction combined transform coding may proceed from the root node down to the voxel level. In each RAHT transform process, prediction and transform coding may be performed on the attribute information based on a 2×2×2 block.

A structure of a coding block for attribute information may be illustrated in FIG. 24. A dark gray block in FIG. 24 is a current block to-be-encoded, and light gray blocks are adjacent blocks that are coplanar or collinear with the current block. Attribute information of the current block may be normalized based on formulas (21) to (23):

A_{node}=Σ_{p∈node} attribute(p) (21)

w_{node}=Σ_{p∈node}1=#{p∈node} (22)

a_{node}=A_{node}/w_{node} (23)

Specifically, first, the attribute information of the current block, i.e., A_{node}, can be obtained based on attribute information of nodes in the current block. For example, A_{node} is determined by performing a simple summing operation on the attribute information of the nodes in the current block. Then, the attribute information of the current block may be normalized with the number (i.e., w_{node}) of nodes in the current block, to obtain an average a_{node} of the attribute information of the current block. Next, transform coding may be performed based on the average of the attribute information of the current block.

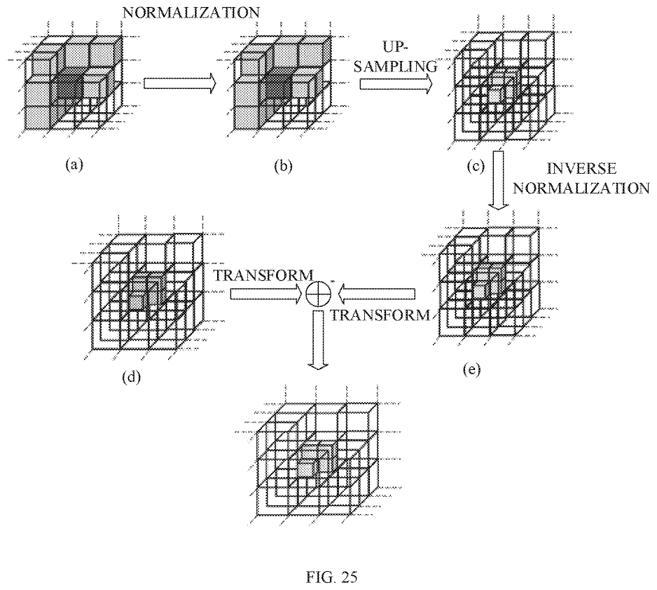

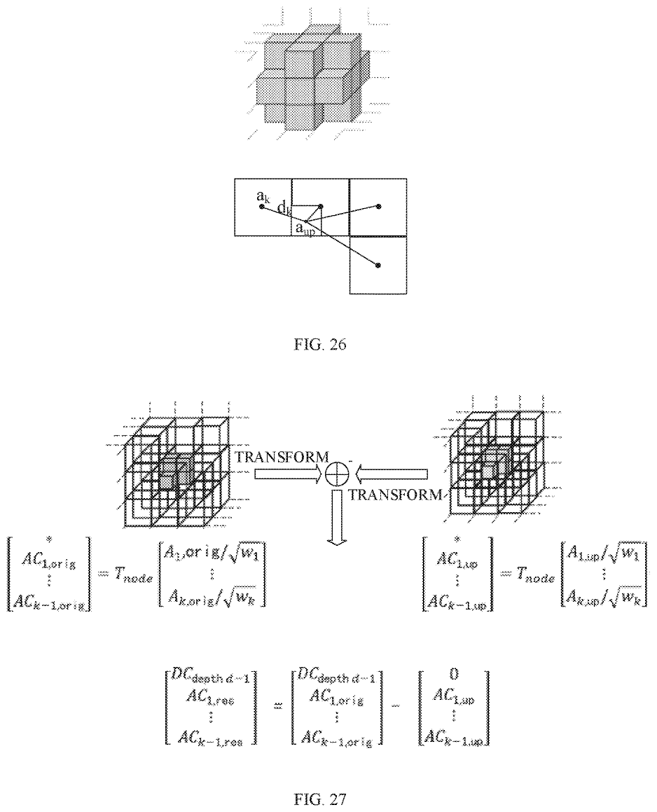

FIG. 25 illustrates an overall process of RAHT intra prediction combined transform coding of attribute information. Herein, (d) in FIG. 25 represents attribute information of a current block, and (e) in FIG. 25 represents attribute information of a prediction block obtained by performing linear weighted fitting based on neighbourhood attribute information of the current block. Then, attribute transform may be performed on the attribute information of the current block and the attribute information of the prediction block respectively, to obtain DC coefficients and AC coefficients. Then, predictive coding may be performed on the AC coefficients. The attribute information of the prediction block is obtained by performing linear fitting based on the manner illustrated in FIG. 26.

FIG. 26 is a diagram of an example linear fitting manner of neighbourhood attribute information of a current block. As illustrated in FIG. 26, 19 adjacent blocks of the current block may be first determined. Next, linear weighted prediction may be performed on attribute information of each sub-block of the current block based on spatial geometry distances between the adjacent blocks and the sub-block, to obtain attribute information of a prediction block. Then, transform may be performed on the attribute information of the prediction block. Exemplarily, formulas (24) to (26) in FIG. 27 may be used for prediction and transform of attribute information (where formula (24) represents a transform method for attribute information of the current block, formula (25) represents a transform method for the attribute information of the prediction block, and predicted residual information is output in formula (26)):

$$[ \begin{matrix}* \\ {AC}_{1 , orig} \\ ⋮ \\ {AC}_{k - 1 , orig}\end{matrix} ] = {T}_{node} [ \begin{matrix}{A}_{1} , orig / \sqrt{{w}_{1}} \\ ⋮ \\ {A}_{k , orig} / \sqrt{{w}_{k}}\end{matrix} ] \qquad ( 24 )$$

$$[ \begin{matrix}* \\ {AC}_{1 , up} \\ ⋮ \\ {AC}_{k - 1 , up}\end{matrix} ] = {T}_{node} [ \begin{matrix}{A}_{1 , up} / \sqrt{{w}_{1}} \\ ⋮ \\ {A}_{k , up} / \sqrt{{w}_{k}}\end{matrix} ] \qquad ( 25 )$$

$$[ \begin{matrix}{DC}_{depth d - 1} \\ {AC}_{1 , res} \\ ⋮ \\ {AC}_{k - 1 , res}\end{matrix} ] = \begin{matrix}{DC}_{depth d - 1} \\ {AC}_{1 , orig} \\ ⋮ \\ {AC}_{k - 1 , orig}\end{matrix} ] - [ \begin{matrix}0 \\ {AC}_{1 , up} \\ ⋮ \\ {AC}_{k - 1 , up}\end{matrix} ] \qquad ( 26 )$$

It may also be understood that for the G-PCC coding framework, common test conditions are as follows.
(1) There are four test conditions in total: condition 1, limit-lossy geometry position and lossy attribute; condition 2, lossless geometry position and lossy attribute; condition 3, lossless geometry position and limit-lossy attribute; and condition 4, lossless geometry position and lossless attribute.
(2) There are four categories of common test sequences, namely Cat1A, Cat1B, Cat3-fused, and Cat3-frame. Cat3-frame point cloud contains only reflectance attribute information, Cat1A point cloud and Cat1B point cloud each contain only colour attribute information, and Cat3-fused point cloud contains both the colour attribute information and the reflectance attribute information.
(3) Technical route: based on algorithms used for geometry compression, there are two technical routes in total.

### Technical Route 1: Octree Coding Branch

At the encoding end, a bounding box is sequentially partitioned into sub-cubes, and non-empty (containing points in a point cloud) sub-cubes are continued to be partitioned until a resulting leaf node is 1×1×1 unit cube. In case of lossless geometry encoding, the number of points contained in the leaf node is encoded, and finally encoding of a geometry octree is completed, to generate a binary bitstream.

At the decoding end, the decoding end obtains an occupancy code of each node through continuous parsing in the order of breadth-first search, and sequentially partitions a node until a 1×1×1 unit cube is obtained. In case of lossless geometry decoding, the decoding end needs to parse out the number of points contained in each leaf node and finally restore geometry-reconstructed point cloud information.

### Technical Route 2: Prediction Tree Coding Branch

At the encoding end, a prediction tree structure is built in two different modes: based on KD-Tree (high-latency slow mode) and based on lidar calibration information (low-latency fast mode). By using the lidar calibration information, each point is assigned to a different laser, and the prediction tree structure is built based on the different laser. Next, based on the prediction tree structure, by traversing each node in the prediction tree, geometry position information of the node is predicted by selecting a different prediction mode to obtain a prediction residual, and the geometry prediction residual is quantized by using a quantization parameter. Finally, the prediction residual of the position information of the prediction tree node, the prediction tree structure, the quantization parameter, and the like are encoded through continuous iteration, to generate a binary bitstream.

At the decoding end, the decoding end reconstructs a prediction tree structure by continuously parsing a bitstream. Then, the decoding end obtains prediction residual information of a geometry position of each prediction node and a quantization parameter through parsing, and performs inverse quantization on the prediction residual to restore reconstructed geometry position information of each node. Finally, geometry reconstruction at the decoding end is completed.

In the following, a geometry-based solid content test model (GES-TM) coding framework is taken as an example for more detailed illustration of an RAHT-based coding scheme for attribute information.

In the GES-TM coding framework, during inter prediction coding of the attribute information, if inter prediction coding is enabled, an RAHT attribute transform coding structure is first constructed based on geometry information of a current node. That is, the node merge proceeds from the voxel level until a root node of the whole RAHT transform tree is obtained, thereby obtaining a transform coding hierarchical structure of the attribute information. Next, according to the RAHT transform structure, the root node may be partitioned to obtain N child nodes (where Nis less than or equal to 8) of each node. Different from an RAHT intra prediction combined transform coding mode, node information of a reference picture is used in an RAHT inter prediction combined transform coding mode. For example, RAHT transform may be performed on attribute information of N child nodes of the current node to obtain DC and AC coefficients, and then inter prediction may be performed on the AC coefficients of the N child nodes in the following manners.

For example, if an inter prediction node of the current node is valid (that is, a collocated node of the current node in the reference picture exists), then attribute information of the prediction node is directly used as an attribute prediction value of the current node.

For another example, for the current node, if a node at exactly the same position as the current node can be found in a buffer of the reference picture (that is, a collocated node of the current node in the reference picture exists), then attribute prediction values of AC coefficients of the N child nodes of the current node may be determined based on AC coefficients of M child nodes contained in the collocated node. Exemplarily, if an AC coefficient of an inter prediction node of a certain child node is not zero, the AC coefficient of the inter prediction node is directly used as a prediction value of the certain child node. If an AC coefficient of an inter prediction node of a certain child node is zero, an AC coefficient of an intra prediction node of the certain child node may be used as a prediction value.

For another example, if an inter prediction node of the current node is invalid (that is, a collocated node of the current node in the reference picture does not exist), then an attribute prediction value of an intra neighbouring node may be used as an attribute prediction value of the current node.

In addition, after RAHT inter prediction is enabled, an optimal RAHT prediction mode may be selected for each layer. This RAHT prediction mode may be an RAHT intra prediction mode or an RAHT inter prediction mode. If a cost of the RAHT intra prediction mode is less than a cost of the RAHT inter prediction mode, RAHT intra prediction may be performed on a current layer, and otherwise, RAHT inter prediction is performed on the current layer.

In the GES-TM coding framework, a coding mode may be selected for each node in the related art to code attribute information of an RAHT layer. A manner of selecting a coding mode for a node in the related art will be described in detail below.

In the related art, whether to perform inter prediction on a current coding unit may be determined according to a syntax element (for example, attrInterPredictionEnabled) in a high-level attribute parameter set (APS). If inter prediction coding is enabled for the current coding unit, a coding mode for an attribute of a different RAHT layer needs to be further determined according to a syntax element (for example, rahtUpperModeLevel) in an APS.

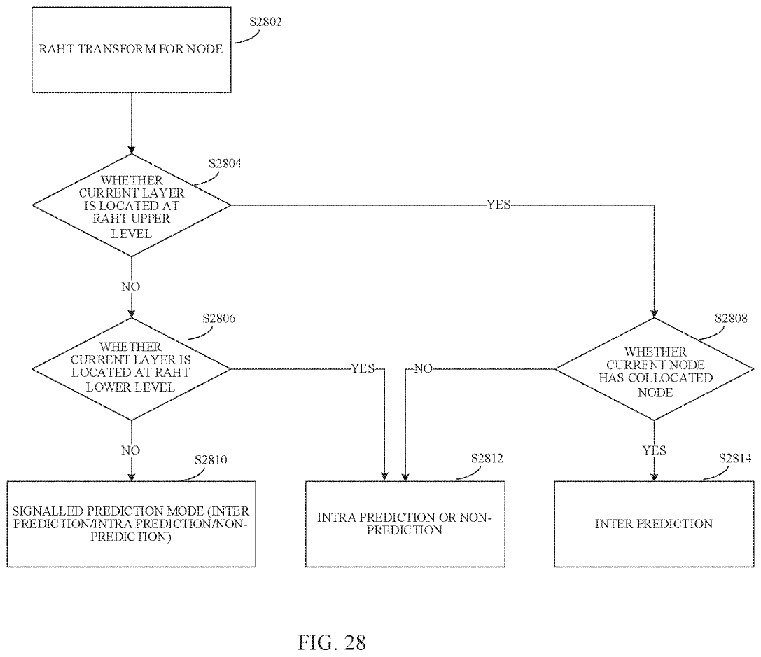

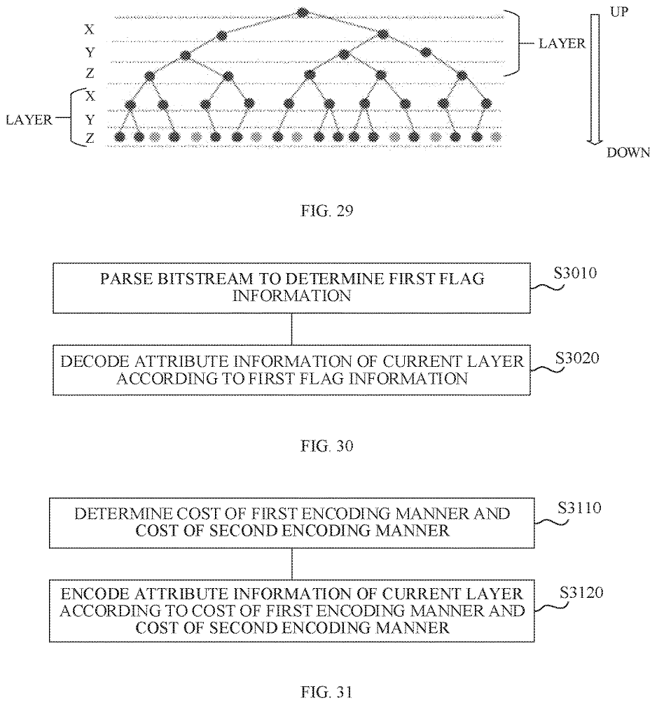

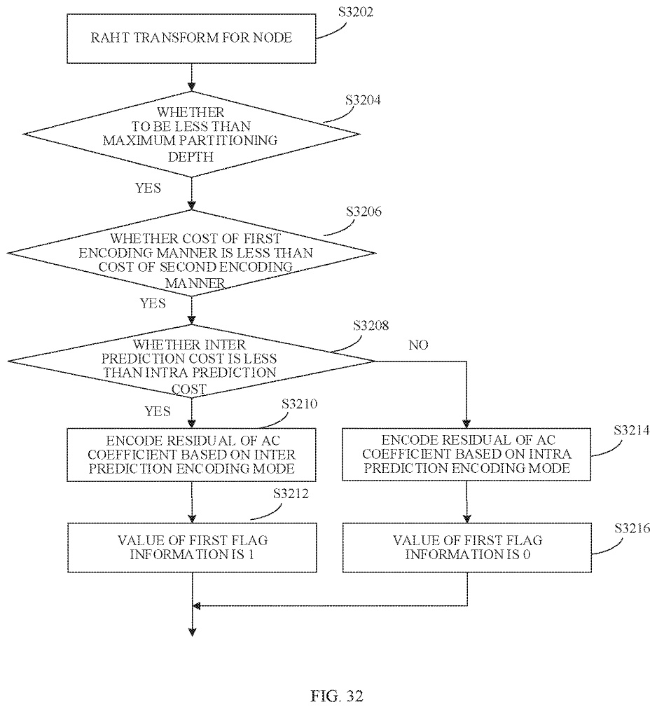

FIG. 28 is a schematic flowchart of inter prediction of attribute information of an RAHT layer. As illustrated in FIG. 28, at S2802, RAHT transform is performed on a node, to form multiple RAHT layers (as illustrated in FIG. 29). For the multiple RAHT layers, their respective RAHT levels may be determined based on partitioning depths of the RAHT layers. Exemplarily, as illustrated in FIG. 29, if a partitioning depth of the RAHT layer falls within a range of an RAHT upper level, it indicates that a current layer is located at the RAHT upper level. If the partitioning depth of the RAHT layer falls within a range of an RAHT middle level, it indicates that the current layer is located at the RAHT middle level. If the partitioning depth of the RAHT layer falls within a range of an RAHT lower level, it indicates that the current layer is located at the RAHT lower level.

At S2804, whether the current layer is located at the RAHT upper level is determined. If the current layer is located at the RAHT upper level, operations at S2808 are performed, and otherwise, operations at S2806 are performed.

At S2806, whether the current layer is located at the RAHT lower level is determined. If the current layer is located at the RAHT lower level, operations at S2812 are performed. Otherwise, the current layer is located at the RAHT middle level, and in this case, operations at S2810 are performed.

At S2808, whether a current node has a collocated node is determined. If the current node is located at the RAHT upper level, a coding mode for the current node is determined according to whether the current node has a collocated node. If the collocated node exists, operations at S2814 are performed, that is, RAHT inter prediction combined transform coding is applied. Otherwise, the operations at S2812 are performed, that is, RAHT intra prediction combined transform coding is applied.

At S2810, if the current node is located at the RAHT middle level, an optimal coding mode for the current node is adaptively selected from three coding modes based on an RDO algorithm, and the determined coding mode is finally transmitted to the decoding end. The above three coding modes include RAHT inter prediction combined transform coding, RAHT intra prediction combined transform coding, and RAHT transform coding.

At S2812, if the current node is located at the RAHT lower level, the coding mode for the current node is adaptively determined according to a neighbourhood mode for the current node. For example, if the number of adjacent nodes of the current node is greater than a certain threshold, RAHT intra prediction combined transform coding is performed, and otherwise, prediction is skipped, that is, RAHT transform coding is performed.

As can be seen from the above description, in the GES-TM-based coding framework, during coding of attribute information of a point cloud, if RAHT inter prediction is enabled, a coding mode is selected for each node in an RAHT layer in the related art. However, this coding manner in the related art is generally a locally optimal coding manner. That is, an optimal coding mode for a node may not be an optimal coding mode for the entire RAHT layer. For example, in the related art, after one coding mode is determined for each node, coding modes for all nodes need to be signalled in a bitstream, which increases encoded bits for information of the coding modes, thereby limiting the coding efficiency of the attribute information to a certain extent. Therefore, how to improve the coding efficiency of the attribute information of the point cloud is a problem to be solved.

In view of the above problem, a point cloud encoding method is provided in embodiments of the disclosure. The method includes the following. A cost of a first encoding manner and a cost of a second encoding manner are determined. Attribute information of a current layer is encoded according to the cost of the first encoding manner and the cost of the second encoding manner. The current layer is any one of multiple RAHT layers. In the first encoding manner, nodes in the current layer correspond to the same encoding mode. In the second encoding manner, encoding modes for nodes in the current layer need to be determined respectively.

A point cloud decoding method is provided in embodiments of the disclosure. The method includes the following. A bitstream is parsed to determine first flag information. Attribute information of a current layer is decoded according to the first flag information. The current layer is any one of multiple RAHT layers. The first flag information indicates whether a first decoding manner or a second decoding manner is to be used for the current layer. In the first decoding manner, nodes in the current layer correspond to the same decoding mode. In the second decoding manner, decoding modes for nodes in the current layer need to be determined respectively.

The reason why an RAHT-based coding scheme provided in the related art has low efficiency is that a coding mode is determined for each node in an RAHT layer in this scheme. Although this scheme can make the coding mode for each node the better (or even the best) coding mode for that node, determining a coding mode(s) node by node results in low coding efficiency. Different from the related art, a coding scheme for the RAHT layer is introduced in embodiments of the disclosure. If this coding scheme is selected, nodes in the RAHT layer correspond to the same coding mode. That is to say, in embodiments of the disclosure, the RAHT layer is considered as a coding unit, and a coding mode is determined at a granularity of the RAHT layer. The granularity of the RAHT layer is slightly larger than a granularity of a node, but the granularity of the RAHT layer is smaller than a granularity of a slice. Therefore, for a coding unit with the granularity of the RAHT layer, the coding efficiency of attribute information of a point cloud can be improved as much as possible on the premise of ensuring relatively high coding accuracy.

A point cloud decoding method provided in embodiments of the disclosure will be described in detail below with reference to the accompanying drawings.

FIG. 30 is a schematic flowchart of a point cloud decoding method provided in embodiments of the disclosure. The decoding method in FIG. 30 may be applied to a decoder. The decoding method in FIG. 30 may be used for decoding attribute information of a point cloud. In some implementations, the decoding method may be applied to G-PCC. Alternatively, in some other implementations, the decoding method may be applied to a GES-TM. The GES-TM is a coding framework proposed for dense point clouds (for example, point clouds collected in augmented reality (AR) or virtual reality (VR) scenarios).

As illustrated in FIG. 30, at S3010, a bitstream is parsed to determine first flag information. The first flag information indicates whether a first decoding manner or a second decoding manner is to be used for decoding a current layer. The first flag information may be located in an attribute brick header (ABH).

In the first decoding manner, nodes in the current layer may be decoded based on the same decoding mode. In the second decoding manner, nodes in the current layer may be decoded based on their respective decoding modes.

A decoding mode indicated by the first flag information may be determined based on a rate-distortion cost of the first decoding manner and a rate-distortion cost of the second decoding manner. For example, the decoding mode may be a decoding mode with a minimum rate-distortion cost in the first decoding manner and the second decoding manner. For rate-distortion cost calculation, reference can be made to the description at the encoder side, which will not be described in detail herein.

In some implementations, the first flag information may be represented by attr_code_mode[i] (of course, the first flag information may also be represented by any other letter and/or number). For example, the first flag information may have a first value (for example, 1 or true) and a second value (for example, 0 or false). If a value of the first flag information is the first value, it may indicate that the first decoding manner is to be used for decoding the current layer. If the value of the first flag information is the second value, it may indicate that the second decoding manner is to be used for decoding the current layer.

The current layer may also be referred to as an RAHT layer, an RAHT decoding layer, an RAHT attribute decoding layer, or an RAHT transform layer. The current layer may be determined based on at least one partitioning (or down-sampling) of a previous layer of the current layer along each of an X direction, a Y direction, and a Z direction.

Multiple RAHT layers may be divided into multiple level ranges. For example, the multiple RAHT layers may be divided into a first level range, a second level range, and a third level range. The first level range may be a highest level of the multiple RAHT layers, and thus may also be referred to as an RAHT upper level. The second level range may be a middle level of the multiple RAHT layers, and thus may also be referred to as an RAHT middle level. The third level range may be a lowest level of the multiple RAHT layers, and thus may also be referred to as an RAHT lower level. The current layer may be located at any level in the multiple level ranges.

At S3020, attribute information of the current layer is decoded according to the first flag information.

As mentioned above, the first flag information may indicate that a decoding manner for the current layer is the first decoding manner or the second decoding manner. In some implementations, if the first flag information indicates the first decoding manner, the attribute information of the current layer may be decoded as follows. The bitstream is parsed to determine second flag information, where the second flag information indicates a target decoding mode. Then, attribute information of nodes in the current layer are decoded according to the target decoding mode.

The target decoding mode indicated by the second flag information may be referred to as an optimal decoding mode for the current layer. The target decoding mode may be determined based on rate-distortion costs of multiple decoding modes. For example, the target decoding mode may be a decoding mode with a minimum rate-distortion cost among the multiple decoding modes. For rate-distortion cost calculation, reference can be made to the description at the encoder side, which will not be described in detail herein.

In some implementations, the multiple decoding modes mentioned above may include: an RAHT transform decoding mode, an RAHT intra prediction combined transform decoding mode, an RAHT inter prediction combined transform decoding mode, and a combination of the RAHT intra prediction combined transform decoding mode and the RAHT inter prediction combined transform decoding mode (for example, if a node to be decoded has a collocated node in a reference picture, RAHT inter prediction combined transform decoding is performed, and if the collocated node does not exist, RAHT intra prediction combined transform decoding is performed).

In some implementations, the second flag information may be represented by attr_pred_mode[i] (of course, the second flag information may also be represented by any other letter and/or number). For example, the second flag information may have a first value (for example, 1 or true) and a second value (for example, 0 or false). If a value of the second flag information is the first value, it may indicate that the RAHT inter prediction combined transform decoding mode is to be used for decoding the current layer. If the value of the second flag information is the second value, it may indicate that the RAHT intra prediction combined transform decoding mode is to be used for decoding the current layer.

In some implementations, if the first flag information indicates the second decoding manner, the attribute information of the current layer may be decoded as follows. A decoding mode for a current node in the current layer is determined. Then, attribute information of the current node is decoded according to the decoding mode for the current node.

In embodiments of the disclosure, in the second decoding manner, a decoding mode is determined for each node in the RAHT layer. If the efficiency of the second decoding manner is relatively low, the first decoding manner may be used for decoding in embodiments of the disclosure. A decoding mode for the RAHT layer is introduced in the first decoding manner. If the first decoding manner is selected, nodes in the RAHT layer correspond to the same decoding mode, thereby improving the decoding efficiency of attribute information.

A manner of determining the decoding mode for the current node in the current layer is not limited in embodiments of the disclosure. In some implementations, the manner of determining the decoding mode for the current node in the current layer is correlated with a level range of the current layer. As mentioned above, the current layer may be located within any one of level ranges, namely the RAHT upper level, the RAHT middle level, or the RAHT lower level. When the current layer is located within the above different level range, the manner of determining the decoding mode for the current node in the current layer is also different, which will be described in detail below.

In some implementations, if the current layer is located at the RAHT upper level, the decoding mode for the current node in the current layer may be determined as follows. The decoding mode for the current node is determined according to whether a reference picture contains a collocated node of the current node. For example, if the collocated node of the current node exists, the decoding mode for the current node may be RAHT inter prediction combined transform decoding. For another example, if the collocated node of the current node does not exist, the decoding mode for the current node may be RAHT intra prediction combined transform decoding.

In some implementations, if the current layer is located at the RAHT middle level, the decoding mode for the current node in the current layer may be determined as follows. The decoding mode for the current node is indicated by third flag information obtained by parsing the bitstream. The above decoding mode may include an RAHT transform decoding mode, an RAHT intra prediction combined transform decoding mode, and an RAHT inter prediction combined transform decoding mode. For example, a decoding mode with a minimum rate-distortion cost among the RAHT transform decoding mode, the RAHT intra prediction combined transform decoding mode, and the RAHT inter prediction combined transform decoding mode may be determined as the decoding mode indicated by the third flag information.

In some implementations, if the current layer is located at the RAHT lower level, the decoding mode for the current node in the current layer may be determined as follows. The decoding mode for the current node is determined according to an adjacent node of the current node. For example, if the number of adjacent nodes of a parent node of the current node is greater than a first threshold and the number of adjacent nodes of a grandparent node of the current node is greater than a second threshold, the decoding mode for the current node is an RAHT intra prediction combined transform decoding mode. For another example, if the number of adjacent nodes of the parent node of the current node is less than or equal to the first threshold and/or the number of adjacent nodes of the grandparent node of the current node is less than or equal to the second threshold, the decoding mode for the current node is an RAHT transform decoding mode. As mentioned above, the multiple decoding modes may include RAHT inter prediction combined transform decoding. A reference picture for the RAHT inter prediction combined transform decoding may be a non-motion-compensated reference picture, or may be a motion-compensated reference picture. Further, in some implementations, both a first reference picture and a second reference picture may be introduced for the RAHT inter prediction combined transform decoding. The first reference picture is a reference picture that is subject to motion compensation (which may refer to local motion compensation or global motion compensation), and the second reference picture is a reference picture that is not subject to motion compensation (which may refer to local motion compensation or global motion compensation). At the encoder side, inter prediction may be performed based on the first reference picture and the second reference picture, and an appropriate reference picture may be selected based on rate-distortion costs. Then, fourth flag information may be signalled in the bitstream to indicate the reference picture for the RAHT inter prediction combined transform decoding. At the decoder side, the fourth flag information may be obtained by parsing the bitstream, to determine the reference picture for the RAHT inter prediction combined transform decoding. By taking both the motion-compensated reference picture and the non-motion-compensated reference picture into consideration, it is conducive to improving the coding performance.

In some implementations, the bitstream may be parsed to determine fourth flag information. The fourth flag information indicates whether a motion-compensated reference picture is to be used for RAHT inter prediction.

For example, the fourth flag information may have a first value (for example, 1 or true) and a second value (for example, 0 or false). If a value of the fourth flag information is the first value, it indicates that the motion-compensated reference picture may be used for RAHT inter prediction. If the value of the fourth flag information is the second value, it indicates that only a non-motion-compensated reference picture is to be used for RAHT inter prediction.

The fourth flag information may correspond to a slice. That is to say, the fourth flag information may be slice-level information, which indicates whether the motion-compensated reference picture may be used for RAHT inter prediction of the slice. Alternatively, the fourth flag information may correspond to an RAHT layer. That is to say, the fourth flag information may be RAHT layer-level information, which indicates whether the motion-compensated reference picture may be used for RAHT inter prediction of the RAHT layer.

In some implementations, if the target decoding mode is a combination of RAHT intra prediction combined transform decoding and RAHT inter prediction combined transform decoding, the attribute information of the current layer may be decoded as follows. An intra prediction value and an inter prediction value of an AC coefficient of a node in the current layer is determined according to the target decoding mode. A target prediction value of the AC coefficient is determined by fusing the intra prediction value and the inter prediction value. Reconstructed attribute information of the node in the current layer is determined according to the target prediction value. By fusing an intra prediction result and an inter prediction result, it is conducive to improving the accuracy of prediction information, thereby improving the coding performance of attribute information.

For example, an arithmetic average value of the intra prediction value and the inter prediction value may be determined as the target prediction value.

For another example, the target prediction value may be determined by performing a weighted summation on the intra prediction value and the inter prediction value. Assuming that an intra prediction value of an AC coefficient of the current node (which may be any node in the current layer) is predIntraVal, and an inter prediction value of the AC coefficient is predInterVal, a target prediction value predVal may be calculated based on formula (27):

predVal=w1*predIntraVal+w2*predInterVal (27)
where w1 and w2 represent a weight of predIntraVal and a weight of predInterVal, respectively.

The weights of the intra prediction value and the inter prediction value of the AC coefficient of the current node may be determined in multiple manners, which is not limited in embodiments of the disclosure. For example, the weights of the intra prediction value and the inter prediction value may be determined based on the number of adjacent nodes during intra prediction. The greater the number of adjacent nodes during intra prediction, the higher the weight of the intra prediction value. Alternatively, multiple weights may be pre-defined for each of the intra prediction value and the inter prediction value, and then an optimal weight is determined based on an RDO algorithm.

In some implementations, the reconstructed attribute information of the node in the current layer may be determined according to the target prediction value as follows. A reconstructed value of the AC coefficient is determined according to the target prediction value of the AC coefficient and a prediction residual value of the AC coefficient. Then, a reconstructed value of attribute information of the node in the current layer is determined by performing inverse transform on the reconstructed value of the AC coefficient and a DC coefficient of the node in the current layer.

In some implementations, if the target decoding mode is a combination of RAHT intra prediction combined transform decoding and RAHT inter prediction combined transform decoding, the attribute information of the current layer may be decoded as follows. Whether an inter prediction value of an AC coefficient of a node in the current layer is zero is determined. If the inter prediction value is not zero, a prediction value of the AC coefficient may be determined to be the inter prediction value. If the inter prediction value is zero, the prediction value of the AC coefficient of the node in the current layer may be determined to be an intra prediction value.

In some implementations, whether to perform operations at S3010 may be determined based on a certain condition. For example, whether attribute information of the node in the current layer satisfies a condition for inter prediction may be first determined. If the attribute information satisfies the condition for inter prediction, the operations at S3010 are performed, and otherwise, the operations at S3010 may be skipped. The condition for inter prediction may be, for example, whether a current picture is a P picture or a B picture.

In some implementations, before whether the attribute information of the node in the current layer satisfies the condition for inter prediction is determined, whether attribute prediction decoding may be applied for the current layer may be first determined. For example, whether attribute prediction decoding may be applied for the current layer may be determined according to the number of adjacent nodes in the current layer and/or the number of adjacent nodes of a parent node of the node in the current layer. Exemplarily, if the number of adjacent nodes in the current layer is greater than or equal to a third threshold and/or the number of adjacent nodes of the parent node of the node in the current layer is greater than or equal to a fourth threshold, it is determined that attribute prediction decoding may be applied for the current layer.

In some implementations, if the attribute information of the node in the current layer does not satisfy the condition for inter prediction, RAHT transform decoding and/or RAHT intra prediction combined transform decoding is performed on the attribute information.

The point cloud decoding method provided in embodiments of the disclosure is described in detail above with reference to FIG. 30. A point cloud encoding method provided in embodiments of the disclosure will be described in detail below with reference to FIG. 31.

FIG. 31 is a schematic flowchart of a point cloud encoding method provided in embodiments of the disclosure. The encoding method in FIG. 31 may be applied to an encoder. The encoding method in FIG. 31 may be used for encoding attribute information of a point cloud. In some implementations, the encoding method may be applied to G-PCC. Alternatively, in some other implementations, the encoding method may be applied to a GES-TM. The GES-TM is a coding framework proposed for dense point clouds (for example, point clouds collected in AR or VR scenarios).

As illustrated in FIG. 31, at S3110, a cost of a first encoding manner and a cost of a second encoding manner are determined.

The cost of the first encoding manner may refer to a rate-distortion cost of the first encoding manner, and the cost of the second encoding manner may refer to a rate-distortion cost of the second encoding manner. The above rate-distortion cost may be determined based on a distortion parameter, a bitrate parameter, and a Lagrange multiplier corresponding to the first encoding manner (or the second encoding manner). For example, for each encoding mode, a distortion parameter may be determined according to reconstructed attribute information and original attribute information corresponding to the encoding mode, and then the number of encoded bits required for the encoding mode may be determined, so as to determine a bitrate parameter. Next, a rate-distortion cost of the encoding mode may be determined based on the following formula (28):

J=D+λ×R (28)
where J represents the rate-distortion cost, D represents the distortion parameter, R represents the bitrate parameter, and X represents a Lagrange multiplier.

The Lagrange multiplier may be determined based on a quantization parameter of attribute information of a node in a current layer. For example, a value of X may be determined based on the following formula (29):

$$λ = {2}^{\frac{QP - 4}{6}} \times N \qquad ( 29 )$$

where QP represents the quantization parameter of the attribute information. N may be a pre-defined value. A value of N may be associated with a type of the attribute information. For example, the value of N may be different for reflectance and colour information.

At S3120, attribute information of a current layer is encoded according to the cost of the first encoding manner and the cost of the second encoding manner.

The current layer may also be referred to as an RAHT layer, an RAHT encoding layer, an RAHT attribute encoding layer, or an RAHT transform layer. The current layer may be determined based on at least one partitioning (or down-sampling) of a previous layer of the current layer along each of an X direction, a Y direction, and a Z direction.

Multiple RAHT layers may be divided into multiple level ranges. For example, the multiple RAHT layers may be divided into a first level range, a second level range, and a third level range. The first level range may be a highest level of the multiple RAHT layers, and thus may also be referred to as an RAHT upper level. The second level range may be a middle level of the multiple RAHT layers, and thus may also be referred to as an RAHT middle level. The third level range may be a lowest level of the multiple RAHT layers, and thus may also be referred to as an RAHT lower level. The current layer may be located at any level in the multiple level ranges.

In the first encoding manner, nodes in the current layer may be encoded based on the same encoding mode. In the second encoding manner, nodes in the current layer may be encoded based on their respective encoding modes.

In operations at S3120, an encoding mode for the current layer may be determined according to a rate-distortion cost for encoding the current layer in the first encoding manner (the second encoding manner). For example, if the rate-distortion cost for encoding the current layer in the first encoding manner is less than a rate-distortion cost for encoding the current layer in the second encoding manner, the first encoding manner is selected as the encoding mode for the current layer.

In embodiments of the disclosure, in the second encoding manner, an encoding mode is determined for each node in the RAHT layer. If the efficiency of the second encoding manner is relatively low, the first encoding manner may be used for encoding in embodiments of the disclosure. An encoding mode for the RAHT layer is introduced in the first encoding manner. If the second encoding manner is selected, nodes in the RAHT layer correspond to the same encoding mode, thereby improving the encoding efficiency of attribute information.

In some implementations, first flag information may be signalled in a bitstream. The first flag information indicates whether the first encoding manner or the second encoding manner is to be used for encoding the current layer. The first flag information may be located in an ABH.

In some implementations, the first flag information may be represented by attr_code_mode[i] (of course, the first flag information may also be represented by any other letter and/or number). For example, the first flag information may have a first value (for example, 1 or true) and a second value (for example, 0 or false). If a value of the first flag information is the first value, it may indicate that the first encoding manner is to be used for encoding the current layer. If the value of the first flag information is the second value, it may indicate that the second encoding manner is to be used for encoding the current layer.

As mentioned above, in the operations at S3120, the encoding mode for the current layer may be determined based on the rate-distortion cost. In some implementations, if the rate-distortion cost of the first encoding manner is less than the rate-distortion cost of the second encoding manner, the encoding mode for the current layer is the first encoding manner. In the first encoding manner, a target encoding mode may be determined from multiple encoding modes, and then attribute information of nodes in the current layer is encoded according to the target encoding mode.

The multiple encoding modes mentioned above may include: an RAHT transform encoding mode, an RAHT intra prediction combined transform encoding mode, an RAHT inter prediction combined transform encoding mode, and a combination of the RAHT intra prediction combined transform encoding mode and the RAHT inter prediction combined transform encoding mode (for example, if a node to be encoded has a collocated node in a reference picture, RAHT inter prediction combined transform encoding is performed, and if the collocated node does not exist, RAHT intra prediction combined transform encoding is performed).

In some implementations, second flag information may be signalled in a bitstream. The second flag information indicates the target encoding mode.

In some implementations, the second flag information may be represented by attr_pred_mode[i] (of course, the second flag information may also be represented by any other letter and/or number). For example, the second flag information may have a first value (for example, 1 or true) and a second value (for example, 0 or false). If a value of the second flag information is the first value, it may indicate that the RAHT inter prediction combined transform encoding mode is to be used for encoding the current layer. If the value of the second flag information is the second value, it may indicate that the RAHT intra prediction combined transform encoding mode is to be used for encoding the current layer.

In some implementations, in the operations at S3120, if the rate-distortion cost of the second encoding manner is less than the rate-distortion cost of the first encoding manner, the encoding mode for the current layer is the second encoding manner. Then, attribute information of a current node is encoded according to an encoding mode for the current node.

A manner of determining the encoding mode for the current node in the current layer is not limited in embodiments of the disclosure. In some implementations, the manner of determining the encoding mode for the current node in the current layer is correlated with a level range of the current layer. As mentioned above, the current layer may be located within any one of level ranges, namely the RAHT upper level, the RAHT middle level, or the RAHT lower level. When the current layer is located within the above different level range, the manner of determining the encoding mode for the current node in the current layer is also different, which will be described in detail below.

In some implementations, if the current layer is located at the RAHT upper level, the encoding mode for the current node in the current layer may be determined as follows. The encoding mode for the current node is determined according to whether a reference picture contains a collocated node of the current node. For example, if the collocated node of the current node exists, the encoding mode for the current node may be RAHT inter prediction combined transform encoding. For another example, if the collocated node of the current node does not exist, the encoding mode for the current node may be RAHT intra prediction combined transform encoding.

In some implementations, if the current layer is located at the RAHT middle level, the encoding mode for the current node in the current layer may be determined as follows. The encoding mode for the current node is determined from multiple encoding modes based on rate-distortion costs. For example, the current node may be encoded based on the multiple encoding modes, and an encoding mode with a minimum rate-distortion cost is determined as the encoding mode for the current node. The multiple encoding modes mentioned herein may include an RAHT transform encoding mode, an RAHT intra prediction combined transform encoding mode, and an RAHT inter prediction combined transform encoding mode. Further, third flag information may be signalled in a bitstream. The third flag information indicates the encoding mode for the current node.

In some implementations, if the current layer is located at the RAHT lower level, the encoding mode for the current node in the current layer may be determined as follows. The encoding mode for the current node is determined according to an adjacent node of the current node. For example, if the number of adjacent nodes of a parent node of the current node is greater than a first threshold and the number of adjacent nodes of a grandparent node of the current node is greater than a second threshold, the encoding mode for the current node is an RAHT intra prediction combined transform encoding mode. For another example, if the number of adjacent nodes of the parent node of the current node is less than or equal to the first threshold and/or the number of adjacent nodes of the grandparent node of the current node is less than or equal to the second threshold, the encoding mode for the current node is an RAHT transform encoding mode. As mentioned above, the multiple encoding modes may include RAHT inter prediction combined transform encoding. A reference picture for the RAHT inter prediction combined transform encoding may be a non-motion-compensated reference picture, or may be a motion-compensated reference picture. Further, in some implementations, both a first reference picture and a second reference picture may be introduced for the RAHT inter prediction combined transform encoding. The first reference picture is a reference picture that is subject to motion compensation (which may refer to local motion compensation or global motion compensation), and the second reference picture is a reference picture that is not subject to motion compensation (which may refer to local motion compensation or global motion compensation). At the encoder side, inter prediction may be performed based on the first reference picture and the second reference picture, and an appropriate reference picture may be selected based on rate-distortion costs. Then, fourth flag information may be signalled in a bitstream to indicate the reference picture for the RAHT inter prediction combined transform encoding. At the decoder side, the fourth flag information may be obtained by parsing the bitstream, to determine the reference picture for the RAHT inter prediction combined transform encoding. By taking both the motion-compensated reference picture and the non-motion-compensated reference picture into consideration, it is conducive to improving the coding performance.

In some implementations, fourth flag information may be signalled in a bitstream. The fourth flag information indicates whether a motion-compensated reference picture is to be used for RAHT inter prediction.

For example, the fourth flag information may have a first value (for example, 1 or true) and a second value (for example, 0 or false). If a value of the fourth flag information is the first value, it indicates that the motion-compensated reference picture may be used for RAHT inter prediction. If the value of the fourth flag information is the second value, it indicates that only a non-motion-compensated reference picture is to be used for RAHT inter prediction.

The fourth flag information may correspond to a slice. That is to say, the fourth flag information may be slice-level information, which indicates whether the motion-compensated reference picture may be used for RAHT inter prediction of the slice. Alternatively, the fourth flag information may correspond to an RAHT layer. That is to say, the fourth flag information may be RAHT layer-level information, which indicates whether the motion-compensated reference picture may be used for RAHT inter prediction of the RAHT layer.

In some implementations, if the target encoding mode is a combination of RAHT intra prediction combined transform encoding and RAHT inter prediction combined transform encoding, the attribute information of the current layer may be encoded as follows. An intra prediction value and an inter prediction value of an AC coefficient of a node in the current layer is determined according to the target encoding mode. A target prediction value of the AC coefficient is determined by fusing the intra prediction value and the inter prediction value. Reconstructed attribute information of the node in the current layer is determined according to the target prediction value. By fusing an intra prediction result and an inter prediction result, it is conducive to improving the accuracy of prediction information, thereby improving the coding performance of attribute information.

For example, an arithmetic average value of the intra prediction value and the inter prediction value may be determined as the target prediction value.

For another example, the target prediction value may be determined by performing a weighted summation on the intra prediction value and the inter prediction value. Assuming that an intra prediction value of an AC coefficient of the current node (which may be any node in the current layer) is predIntraVal, and an inter prediction value of the AC coefficient is predInterVal, a target prediction value predVal may be calculated based on formula (30):

predVal=w1*predIntraVal+w2*predInterVal (30)
where w1 and w2 represent a weight of predIntraVal and a weight of predInterVal, respectively.

The weights of the intra prediction value and the inter prediction value of the AC coefficient of the current node may be determined in multiple manners, which is not limited in embodiments of the disclosure. For example, the weights of the intra prediction value and the inter prediction value may be determined based on the number of adjacent nodes during intra prediction. The greater the number of adjacent nodes during intra prediction, the higher the weight of the intra prediction value. Alternatively, multiple weights may be pre-defined for each of the intra prediction value and the inter prediction value, and then an optimal weight is determined based on an RDO algorithm.

In some implementations, the reconstructed attribute information of the node in the current layer may be determined according to the target prediction value as follows. A reconstructed value of the AC coefficient is determined according to the target prediction value of the AC coefficient and a prediction residual value of the AC coefficient. Then, a reconstructed value of attribute information of the node in the current layer is determined by performing inverse transform on the reconstructed value of the AC coefficient and a DC coefficient of the node in the current layer.

In some implementations, if the target encoding mode is a combination of RAHT intra prediction combined transform encoding and RAHT inter prediction combined transform encoding, the attribute information of the current layer may be encoded as follows. Whether an inter prediction value of an AC coefficient of a node in the current layer is zero is determined. If the inter prediction value is not zero, a prediction value of the AC coefficient may be determined to be the inter prediction value. If the inter prediction value is zero, the prediction value of the AC coefficient of the node in the current layer may be determined to be an intra prediction value.

In some implementations, whether to perform operations at S3110 may be determined based on a certain condition. For example, whether attribute information of the node in the current layer satisfies a condition for inter prediction may be first determined. If the attribute information satisfies the condition for inter prediction, the operations at S3110 are performed, and otherwise, the operations at S3110 may be skipped. The condition for inter prediction may be, for example, whether a current picture is a P picture or a B picture.

In some implementations, before whether the attribute information of the node in the current layer satisfies the condition for inter prediction is determined, whether attribute prediction encoding may be applied for the current layer may be first determined. For example, whether attribute prediction encoding may be applied for the current layer may be determined according to the number of adjacent nodes in the current layer and/or the number of adjacent nodes of a parent node of the node in the current layer. Exemplarily, if the number of adjacent nodes in the current layer is greater than or equal to a third threshold and/or the number of adjacent nodes of the parent node of the node in the current layer is greater than or equal to a fourth threshold, it is determined that attribute prediction encoding may be applied for the current layer.

In some implementations, if the attribute information of the node in the current layer does not satisfy the condition for inter prediction, RAHT transform encoding and/or RAHT intra prediction combined transform encoding is performed on the attribute information.

Embodiments of the disclosure will be described in more detail below in combination with specific examples. It may be noted that, the following examples are merely illustrated for helping those skilled in the art to understand embodiments of the disclosure, and are not intended to limit embodiments of the disclosure to specific values or specific scenarios as illustrated. Apparently, various equivalent modifications or changes can be made by those skilled in the art based on the examples illustrated, and those modifications or changes also fall within the scope of embodiments of the disclosure.

In a GES-TM coding framework, during coding of attribute information of a point cloud, if RAHT inter prediction is enabled, then in the related art, a coding mode is selected for each node in an RAHT layer, and all coding modes are signalled in a bitstream. However, this coding manner in the related art is generally a locally optimal coding manner. That is, an optimal coding mode for a node may not be an optimal coding mode for the entire RAHT layer. For example, in the related art, after one coding mode is determined for each node, coding modes for all nodes need to be signalled in a bitstream, which increases encoded bits for information of the coding modes, thereby limiting the coding efficiency of the attribute information to a certain extent.

In view of the above problem, layer-by-layer selection of an optimal coding mode RAHT layer coding or node coding based on a coding unit of the RAHT layer is proposed in this example. First, the following definitions are given.

RAHT layer coding (first coding manner): Taking the RAHT layer as a coding unit, only one coding mode, such as inter prediction coding or intra prediction coding, needs to be coded for all nodes in the coding unit.

Node coding (second coding manner): A different coding mode, such as intra prediction coding, inter prediction coding, or non-prediction coding, is selected for each node in a current RAHT layer. That is, one mode needs to be coded for each node.

After the above definitions are given, for each RAHT coding layer, in this example, taking the RAHT layer as a coding unit, the encoding end performs adaptive mode selection layer by layer and finally transmits a coding mode for the RAHT-layer coding unit to the decoding end. The decoding end reconstructs and restores attribute information of the current RAHT layer based on a decoding mode for a layer to be decoded, which can ultimately improve the coding efficiency of the attribute information of the point cloud to a certain extent.

In this example, after different RAHT layers are obtained, adaptive mode selection, i.e., selection of the first coding manner or the second coding manner, is performed for each coding unit by taking an RAHT layer as a unit. The RAHT layers may be divided into three main types: an RAHT upper level, an RAHT middle level, and an RAHT lower level. Coding schemes for attributes of these three types of RAHT layers have been mentioned above and will not be repeated herein. A coding method in this example is as follows.

For an RAHT coding upper level, (1) in the first coding manner, taking the current RAHT layer as a coding unit, an optimal coding mode, i.e., inter prediction or intra prediction, is selected for the current RAHT layer, that is, all nodes in the entire RAHT layer correspond to one mode; and (2) in the second coding manner, a coding mode, i.e., inter prediction coding or intra prediction coding, is adaptively selected according to geometry information of a node.

For an RAHT coding middle level, (1) in the first coding manner, taking the current RAHT layer as a coding unit, an optimal coding mode, i.e., inter prediction or intra prediction, is selected for the current RAHT layer, that is, all nodes in the entire RAHT layer correspond to one mode; and (2) in the second coding manner, one mode, i.e., inter prediction, intra prediction, or non-prediction, needs to be adaptively selected and coded for each node, and a finally-selected mode is coded node by node.

For an RAHT coding lower level, (1) in the first coding manner, taking the current RAHT layer as a coding unit, an optimal coding mode, i.e., inter prediction or intra prediction, is selected for the current RAHT layer, that is, all nodes in the entire RAHT layer correspond to one mode; and (2) in the second coding manner, whether intra prediction coding or non-prediction coding is to be applied for a current node is adaptively determined according to the number of adjacent nodes of the node.

During coding of attribute information of the three types of different RAHT layers, the attribute information is pre-coded and reconstructed and restored according to different prediction modes to obtain a comprehensive cost of each mode. Finally, an optimal coding mode for a current layer is obtained based on an RDO algorithm, and the optimal coding mode is transmitted to the decoding end. By using a prediction decoding mode obtained through parsing, the decoding end reconstructs and restores attribute information of points in the current layer to be decoded. In the RDO algorithm, a distortion D between a reconstructed attribute and an original attribute corresponding to each prediction mode is first calculated, and then a bitstream R required for coding each prediction mode is obtained. In this case, a rate-distortion cost is calculated as follows:

J=D+λ×R (31)
where J represents the rate-distortion cost, D represents a distortion parameter, R represents a bitrate parameter, and X represents a Lagrange multiplier.

The Lagrange multiplier may be determined based on a quantization parameter of attribute information of a node in the current layer. For example, a value of X may be determined based on the following formula (32):

$$λ = {2}^{\frac{QP - 4}{6}} \times N \qquad ( 32 )$$

where QP represents the quantization parameter of the attribute information. N may be a pre-defined value. A value of N may be associated with a type of the attribute information. For example, the value of N may be different for reflectance and colour information.

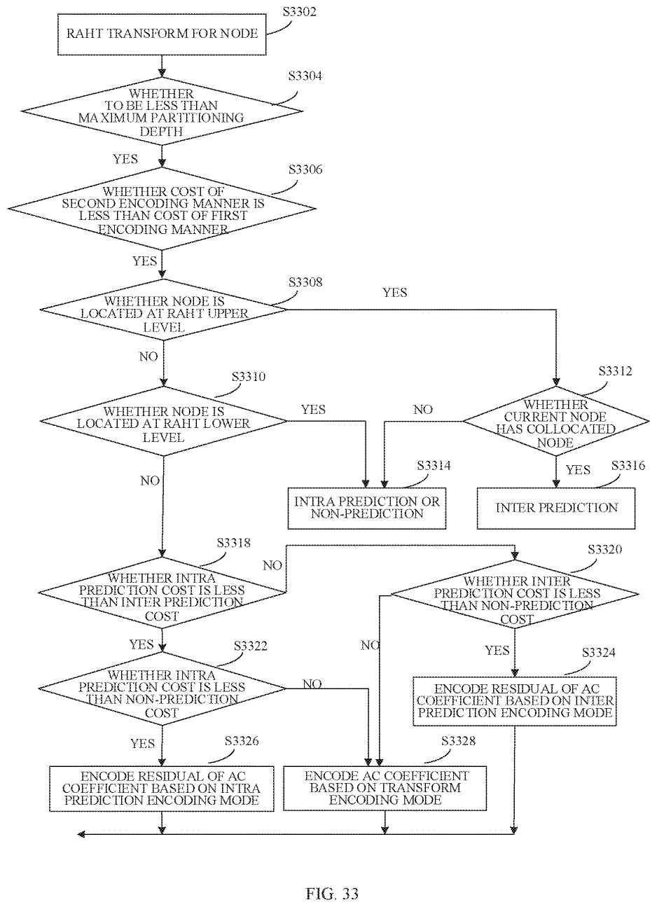

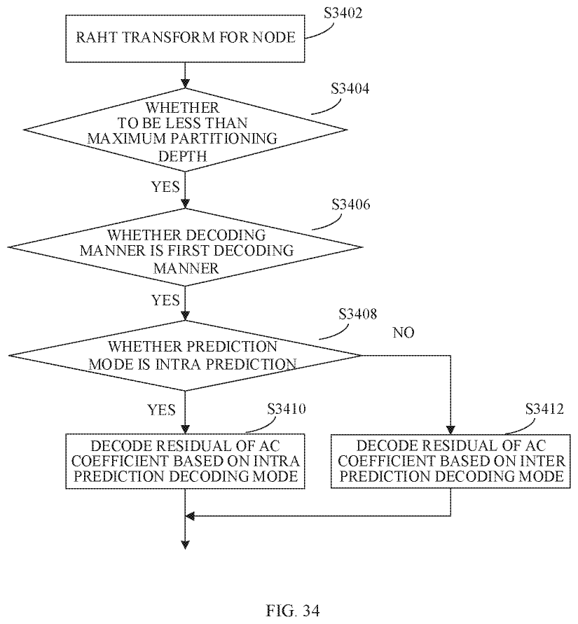

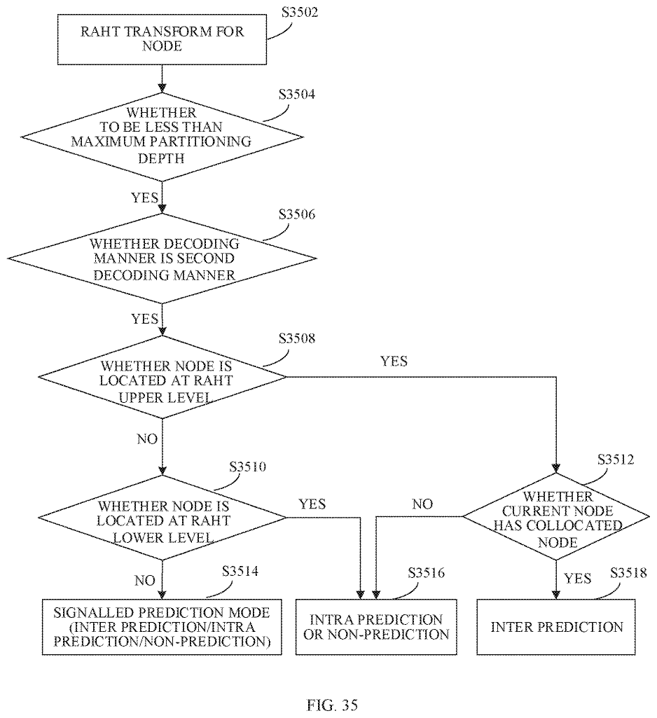

The method process in this example will be separately described in detail below from the encoding end and the decoding end with reference to FIG. 32 to FIG. 35. FIG. 32 corresponds to an encoding process in a first encoding manner in this example. FIG. 33 corresponds to an encoding process in a second encoding manner in this example. FIG. 34 corresponds to a decoding process in a first decoding manner in this example. FIG. 35 corresponds to a decoding process in a second decoding manner in this example.

FIG. 32 corresponds to an encoding process in a first encoding manner in this example. As illustrated in FIG. 32, at S3202, RAHT transform is performed on a node.

At S3204, whether a partitioning depth of a current layer is less than a maximum partitioning depth of an RAHT layer is determined. If the partitioning depth of the current layer is less than the maximum partitioning depth of the RAHT layer, operations at S3206 are performed.

At S3206, whether a cost of the first encoding manner is less than a cost of a second encoding manner is determined. If the cost of the first encoding manner is less than the cost of the second encoding manner, operations at S3208 are performed, and otherwise, an encoding method in FIG. 33 is performed.

Before the operations at S3206 are performed, whether attribute prediction may be applied for a node in the current layer may be adaptively determined according to the number of adjacent nodes in the current layer and the number of adjacent nodes of a parent node. If attribute prediction may be applied for the node in the current layer, the operations at S3206 are performed.

At S3208, whether an inter prediction cost is less than an intra prediction cost is determined. If the inter prediction cost is less than the intra prediction cost, operations at S3210 are performed, and otherwise, operations at S3214 are performed.

At S3210, a residual of an AC coefficient is encoded based on an inter prediction encoding mode.

At S3212, a value of first flag information is set to 1. This means that attribute information of the current layer is encoded based on the inter prediction encoding mode.

At S3214, the residual of the AC coefficient is encoded based on an intra prediction encoding mode.

At S3216, the value of the first flag information is set to 0. This means that the attribute information of the current layer is encoded based on the intra prediction encoding mode.

FIG. 33 corresponds to an encoding process in a second encoding manner in this example. As illustrated in FIG. 33, the first three operations in FIG. 33 are the same as the first three operations in FIG. 32, which will not be repeated herein.

At S3308, whether a node is located at an RAHT upper level is determined. if the node is located at the RAHT upper level, operations at S3312 are performed, and otherwise, operations at S3310 are performed.

At S3310, whether the node is located at an RAHT lower level is determined. If the node is located at the RAHT lower level, operations at S3314 are performed, and otherwise, operations at S3318 are performed.

At S3312, whether a current node has a collocated node is determined. If the collocated node exists, operations at S3316 are performed, and otherwise, the operations at S3314 are performed.

At S3314, intra prediction or non-prediction is applied. Intra prediction encoding or non-prediction encoding (transform encoding) is performed on the current node.

At S3316, inter prediction is applied. Inter prediction is performed on the current node.

At S3318, whether an intra prediction cost is less than an inter prediction cost is determined. If the intra prediction cost is less than the inter prediction cost, operations at S3322 are performed, and otherwise, operations at S3320 are performed.

At S3320, whether the inter prediction cost is less than a non-prediction cost is determined. If the inter prediction cost is less than the non-prediction cost, operations at S3324 are performed, and otherwise, operations at S3328 are performed.

At S3322, whether the intra prediction cost is less than the non-prediction cost is determined. If the intra prediction cost is less than the non-prediction cost, operations at S3326 are performed, and otherwise, the operations at S3328 are performed.

At S3324, a residual of an AC coefficient is encoded based on an inter prediction encoding mode.

At S3326, the residual of the AC coefficient is encoded based on an intra prediction encoding mode.

At S3328, the AC coefficient is encoded based on a transform encoding mode.

In the encoding method in this example, for the node in the current layer, if attribute prediction may be applied and attribute inter prediction may be performed, an RDO algorithm is introduced for the current layer. By encoding each node in the current layer, a cost of each prediction encoding mode (inter prediction encoding combined transform or intra prediction combined transform) is calculated. According to whether the current layer is at an RAHT encoding upper level, an RAHT encoding middle level, or an RAHT encoding lower level, an encoding mode for a current RAHT layer is adaptively determined, and comprehensive costs corresponding to different encoding modes are calculated. Finally, by comparing the comprehensive costs corresponding to the different encoding modes, an optimal encoding mode is selected as the encoding mode for the current RAHT layer.

FIG. 34 corresponds to a decoding process in a first decoding manner in this example. As illustrated in FIG. 34, at S3402, RAHT transform is performed on a node.

At S3404, whether to be less than a maximum partitioning depth is determined. If it is determined to be less than the maximum partitioning depth, operations at S3406 are performed.

At S3406, whether a decoding manner is the first decoding manner is determined. If the decoding manner is the first decoding manner, operations at S3408 are performed, and otherwise, a decoding method in FIG. 35 is performed. For example, whether the decoding manner is the first decoding manner may be determined based on an indication of first flag information.

Before the operations at S3406 are performed, whether attribute prediction may be applied for a node in a current layer is adaptively determined according to the number of adjacent nodes in the current layer and the number of adjacent nodes of a parent node. If attribute prediction may be applied for the node in the current layer, the operations at S3406 are performed.

For the node in the current layer, if attribute prediction may be applied and attribute inter prediction may be performed, an optimal prediction decoding mode for the current layer is obtained based on attr_code_mode[i]. If attr_code_mode[i] is 1, an RAHT layer decoding scheme is used for decoding attribute information of the node in the current layer, and otherwise, an existing GES-TM decoding scheme is used for decoding the attribute information of the node in the current layer.

In terms of using the RAHT layer decoding scheme, a prediction decoding manner, i.e., intra prediction combined transform or inter prediction combined transform, for a current RAHT layer needs to be obtained through further parsing. For example, if attr_pred_mode[i] is 1, then for the current RAHT layer, it is specified that the inter prediction combined transform scheme is used for reconstructing and restoring the attribute information of the node in the current layer. For another example, if attr_pred_mode[i] is 0, then for the current RAHT layer, it is specified that the intra prediction combined transform scheme is used for reconstructing and restoring the attribute information of the node in the current layer.

In terms of using the existing GES-TM decoding scheme, the attribute information of the node in the current layer is reconstructed and restored based on the existing GES-TM decoding scheme.

At S3408, whether a prediction mode is intra prediction is determined. If the prediction mode is intra prediction, operations at S3410 are performed, and otherwise, operations at S3412 are performed.

At S3410, a residual of an AC coefficient is decoded based on an intra prediction decoding mode.

At S3412, the residual of the AC coefficient is decoded based on an inter prediction decoding mode.

FIG. 35 corresponds to a decoding process in a second decoding manner in this example. As illustrated in FIG. 35, the first three operations (operations at S3502, S3504, and S3506) in FIG. 35 are the same as the first three operations in FIG. 34, which will not be repeated herein.

At S3508, whether a node is located at an RAHT upper level is determined. If the node is located at the RAHT upper level, operations at S3512 are performed, and otherwise, operations at S3510 are performed.

At S3510, whether the node is located at an RAHT lower level is determined. If the node is located at the RAHT lower level, operations at S3516 are performed, and otherwise, operations at S3514 are performed.

At S3512, whether a current node has a collocated node is determined. If the collocated node exists, operations at S3518 are performed, and otherwise, the operations at S3516 are performed.

At S3514, a signalled prediction mode (inter prediction/intra prediction/non-prediction) is applied. For example, the prediction mode may be determined based on an indication of second flag information.

At S3516, intra prediction or non-prediction is applied. Intra prediction or non-prediction is performed on the current node.

At S3518, inter prediction is applied. Inter prediction is performed on the current node.

In this example, during inter prediction coding of attribute information, point cloud information is partitioned into different RAHT layers, mode selection, i.e., selection of an RAHT layer encoding mode or an original GES-TM encoding mode, is performed by taking an RAHT layer as a coding unit, and finally, that encoding mode is transmitted to the decoding end. The decoding end reconstructs and restores the attribute information of the node in the current layer based on a decoding mode for the RAHT layer and a corresponding prediction decoding scheme. In this scheme, the focus is on introducing one encoding mode for each RAHT coding layer, obtaining an optimal encoding mode based on an RDO selection algorithm at the encoding end, and then reconstructing attributes of the point cloud based on a decoding mode at the decoding end. Currently, an encoding mode for each layer is stored in an ABH, and a decoding mode for an RAHT coding layer is obtained from the ABH at the decoding end. A form of encoding this parameter is not limited herein.

In embodiments of the disclosure, during inter prediction coding of attribute information, two coding modes, i.e., a first coding manner or a second coding manner, are introduced for each RAHT layer based on a coding unit of an RAHT layer. Based on RDO costs, an optimal coding mode is selected for predictive coding, thereby improving the coding efficiency of attributes of a point cloud. The coding efficiency according to the embodiments of the disclosure will be demonstrated below.

TABLE 2
Test results of coding performance under conditions
of lossless geometry and lossy attributes

lossless geometry, lossy attributes
End-to-End BD-AttrRate[%]

| C1 | Luma | Chroma Cb | Chroma Cr |
|---|---|---|---|
| Cat2-A average | −12.40% | −15.60% | −15.40% |
| Cat2-B average | −0.60% | −0.70% | −0.70% |
| Cat2-Caverage | −6.60% | −7.40% | −9.30% |
| Overall average | −9.00% | −11.10% | −11.60% |

| | |
|---|---|
| Avg. Enc Time[%] | #NUM! |
| Avg. Dec Time[%] | #NUM! |

TABLE 3
Test results of coding performance under conditions
of lossy geometry and lossy attributes

| | lossy geometry, lossy attributes | | | | |
|---|---|---|---|---|---|
| | End-to-End BD-AttrRate[%] | | | Geom. BD- | |
| | | Chroma | Chroma | TotGeomRate[%] | |
| C2 | Luma | Cb | Cr | D1 | D2 |
| Cat2-A average | −14.60% | −16.00% | −15.70% | 0% | 0% |
| Cat2-B average | −0.80% | −0.70% | −0.60% | 0% | 0% |
| Cat2-C average | −4.60% | −4.40% | −4.30% | 0% | 0% |
| Overall average | −9.80% | −10.50% | −10.30% | 0% | 0% |

| | |
|---|---|
| Avg. Enc | #NUM! |
| Time[%] | |
| Avg. Dec | #NUM! |
| Time[%] | |

TABLE 4
Test results of coding performance under conditions
of lossless geometry and lossless attributes

lossless geometry, lossless attributes
bpip ratio[%]

| CW | Geometry | colour | Total |
|---|---|---|---|
| Cat2-A average | 100.00% | 93.60% | 94.10% |
| Cat2-B average | 100.00% | 99.30% | 99.40% |
| Cat2-C average | 100.00% | 99.80% | 99.80% |
| Overall average | 100.00% | 96.40% | 96.70% |

| | |
|---|---|
| Avg. Enc Time[%] | #NUM! |
| Avg. Dec Time[%] | #NUM! |

TABLE 5
Test results of coding performance under conditions
of lossless geometry and lossy attributes

| C1_ai-lossless geometry, lossy attributes [inter] | | | | |
|---|---|---|---|---|
| | | End-to-End BD-AttrRate[%] | | |
| | | | Chroma | Chroma |
| Class | Sequence | Luma | Cb | Cr |
| Cat2-A | 8ivfbv2_loot_vox10 | −10.30% | −20.90% | −20.60% |
| | 8ivfbv2_redandblack_{—} | −2.10% | −2.50% | −2.10% |
| | vox10 | | | |
| | 8ivfbv2_soldier_vox10 | −15.50% | −14.90% | −14.80% |
| | queen | −21.70% | −23.90% | −24.10% |
| Cat2-B | 8ivfbv2_longdress_{—} | −0.60% | −0.70% | −0.70% |
| | vox10 | | | |
| Cat2-C | basketball_{—} | −8.20% | −8.40% | −10.70% |
| | player _vox11 | | | |
| | dancer_player _vox11 | −5.00% | −6.30% | −7.80% |
| | Cat2-A average | −12.40% | −15.60% | −15.40% |
| | Cat2-B average | −0.60% | −0.70% | −0.70% |
| | Cat2-Caverage | −6.60% | −7.40% | −9.30% |
| | Overall average | −9.00% | −11.10% | −11.60% |

TABLE 6
Test results of coding performance under conditions
of lossy geometry and lossy attributes

| C2_ai-lossy geometry, lossy attributes [inter] | | | | |
|---|---|---|---|---|
| | | End-to-End BD-AttrRate[%] | | |
| | | | Chroma | Chroma |
| Class | Sequence | Luma | Cb | Cr |
| Cat2-A | 8ivfbv2_loot_vox10 | −7.80% | −13.20% | −12.30% |
| | 8ivfbv2_redandblack_{—} | −0.60% | −1.50% | −0.70% |
| | vox10 | | | |
| | 8ivfbv2_soldier_vox10 | −19.10% | −17.60% | −17.90% |
| | queen | −31.00% | −31.70% | −32.00% |
| Cat2-B | 8ivfbv2_longdress_{—} | −0.80% | −0.70% | −0.60% |
| | vox10 | | | |
| Cat2-C | basketball_{—} | −5.40% | −7.30% | −6.00% |
| | player _vox11 | | | |
| | dancer_player _vox11 | −3.80% | −1.50% | −2.60% |
| | Cat2-A average | −14.60% | −16.00% | −15.70% |
| | Cat2-B average | −0.80% | −0.70% | −0.60% |
| | Cat2-Caverage | −4.60% | −4.40% | −4.30% |
| | Overall average | −9.80% | −10.50% | −10.30% |

TABLE 7
Test results of coding performance under conditions
of lossless geometry and lossless attributes

| CW_ai-lossless geometry, lossless attributes [inter] | | | | |
|---|---|---|---|---|
| | | bpip ratio[%] | | |
| Class | Sequence | Geometry | colour | Total |
| Cat2-A | 8ivfbv2_loot_vox10 | 100.00% | 99.30% | 99.30% |
| | 8ivfbv2_redandblack_{—} | 100.00% | 99.10% | 99.10% |
| | vox10 | | | |
| | 8ivfbv2_soldier_vox10 | 100.00% | 95.70% | 96.10% |
| | queen | 100.00% | 81.10% | 82.00% |
| Cat2-B | 8ivfbv2_longdress_{—} | 100.00% | 99.30% | 99.40% |
| | vox10 | | | |
| Cat2-C | basketball_{—} | 100.00% | 99.80% | 99.80% |
| | player _vox11 | | | |
| | dancer_player _vox11 | 100.00% | 99.80% | 99.80% |
| | Cat2-A average | 100.00% | 93.60% | 94.10% |
| | Cat2-B average | 100.00% | 99.30% | 99.40% |
| | Cat2-Caverage | 100.00% | 99.80% | 99.80% |
| | Overall average | 100.00% | 96.40% | 96.70% |

TABLE 8
Test results of coding performance under conditions
of lossy geometry and lossy attributes

| C2_ai-lossy geometry, lossy attributes [inter] | | | (For trisoup) | |
|---|---|---|---|---|
| | | End-to-End BD-AttrRate[%] | | |
| | | | Chroma | Chroma |
| Class | Sequence | Luma | Cb | Cr |
| Cat2-A | 8ivfbv2_loot_vox10 | −2.50% | −2.50% | −3.40% |
| | 8ivfbv2_redandblack_{—} | −0.30% | −0.20% | −0.30% |
| | vox10 | | | |
| | 8ivfbv2_soldier_vox10 | −14.50% | −12.50% | −12.60% |
| | queen | −10.40% | −10.20% | −10.40% |
| Cat2-B | 8ivfbv2_longdress_{—} | −0.10% | −0.10% | −0.10% |
| | vox10 | | | |
| Cat2-C | basketball_{—} | −1.60% | −0.80% | −1.20% |
| | player _vox11 | | | |
| | dancer_player _vox11 | −0.90% | −0.60% | −0.70% |
| | Cat2-A average | −6.95% | −6.34% | −6.68% |
| | Cat2-B average | −0.12% | −0.10% | −0.12% |
| | Cat2-Caverage | −1.25% | −0.74% | −0.94% |
| | Overall average | −4.30% | −3.80% | −4.10% |

In the above tables, luma represents luminance, and Cb and Cr represent chrominance. As can be seen from the test results in the above tables, for some sequences, the coding efficiency of attribute information is significantly improved. In particular, under C2 conditions, the performance of luma components of a sequence queen is improved by about 31%, and thus, the coding efficiency of the attributes of the point cloud is significantly improved.

Syntax elements (attribute data unit header syntax) in an ABH are as follows.

| | Descriptor | Semantics |
|---|---|---|
| attribute_data_unit_header( ) { | | |
| adu_attr_parameter_set_id | u(4) | 7.4.4.2 |
| adu_reserved_zero_3bits | u(3) | 7.4.4.2 |
| adu_sps_attr_idx | ue(v) | 7.4.4.2 |
| adu_slice_id | ue(v) | 7.4.4.2 |
| if(lod_dist_log2_offset_present) | | |
| lod_dist_log2_offset | se(v) | 10.6.2 |
| if(last_comp_pred_enabled && AttrDim == 3 ) | | |
| for(dpth = 0; dpth ≤ lod_max_levels_minus1; | | |
| dpth++) | | |
| last_comp_pred_coeff_diff[dpth] | se(v) | 10.6.10.1 |
| if(inter_comp_pred_enabled) | | |
| for(dpth = 0; dpth ≤ lod_max_levels_minus1; | | |
| dpth++) | | |
| for(c = 1; c < AttrDim; c++) | | |
| inter_comp_pred_coeff_diff[dpth][c] | se(v) | 10.6.10.1 |
| if(attr_qp_offsets_present) | | |
| for(qc = 0; qc < Min(2, AttrDim); qc++) | | |
| attr_qp_offset[qc] | se(v) | 10.7.1 |
| attr_qp_layers_present | u(1) | 10.7.1 |
| if(attr_qp_layers_present) { | | |
| attr_qp_layer_cnt_minus1 | ue(v) | 10.7.1 |
| for(dpth = 0; dpth ≤ attr_qp_layer_cnt_minus1; | | |
| dpth++) | | |
| for(qc = 0; qc < Min(2, AttrDim); qc++) | | |
| attr_qp_layer_offset[dpth][qc] | se(v) | 10.7.1 |
| } | | |
| attr_qp_region_cnt | ue(v) | 10.7.1 |
| if(attr_qp_region_cnt) | | |
| attr_qp_region_bits_minus1 | ue(v) | 10.7.1 |
| for(i = 0; i < attr_qp_region_cnt; i++) { | | |
| if(¬attr_coord_conv_enabled) { | | |
| for(k = 0; k < 3; k++) | | |
| attr_qp_region_origin_xyz[i][k] | u(v) | 10.7.1 |
| for(k = 0; k < 3; k++) | | |
| attr_qp_region_size_minus1_xyz[i][k] | u(v) | 10.7.1 |
| } else { | | |
| for(k = 0; k < 3; k++) | | |
| attr_qp_region_origin_rpi[i][k] | u(v) | 10.7.1 |
| for(k = 0; k < 3; k++) | | |
| attr_qp_region_size_minus1_rpi[i][k] | u(v) | 10.7.1 |
| } | | |
| for(ps = 0; ps < Min(2, AttrDim); ps++) | | |
| attr_qp_region_offset[i][ps] | se(v) | 10.7.1 |
| } | | |
| disableAttrInterPred | u(1) | |
| if(attr_coding_type == | | |
| 0&& !disableAttrInterPred&& | | |
| raht_prediction_enabled){ | | |
| attr_code_mode_cnt | ue(v) | |
| for(i = 0; i < attr_code_mode_cnt; i++){ | | |
| attr_code_mode[i] | u(1) | |
| if(attr_code_mode[i]) | | |
| attr_pred_mode[i] | u(1) | |
| } | | |
| } | | |
| byte_alignment( ) | | |
| } | | |

The 11th to 5th last rows in the above table are syntax elements newly introduced in embodiments of the disclosure. A syntax element attr_code_mode_cnt specifies the number of modes for RAHT coding layers when inter prediction coding is enabled for a current slice, which defaults to zero. A syntax element attr_code_mode[i] specifies a mode, i.e., an RAHT layer coding mode or an original coding mode, for each RAHT coding layer when inter prediction coding is enabled for the current slice. A value of 1 indicates that an RAHT layer coding scheme is to be used for a current layer, and a value of 0 indicates that an existing GES-TM coding scheme is to be used for the current layer. A syntax element attr_pred_mode[i] specifies a prediction decoding mode, i.e., inter prediction combined transform or intra prediction combined transform, for a current RAHT layer. A value of 1 indicates that an inter prediction combined transform scheme is to be used for the current layer, and a value of 0 indicates that an intra prediction combined transform scheme is to be used for the current layer.
(1) In embodiments of the disclosure, an attribute inter prediction mode may be further modified.

In an embodiment, based on three existing prediction coding modes: an inter prediction coding mode combined with an intra prediction coding mode, the intra prediction coding mode, and a transform coding mode, a coding mode is introduced for a current RAHT coding layer at the encoding end to represent a prediction coding mode to be used for restoring an AC coefficient of the current RAHT coding layer. In another embodiment, prediction coding modes may be further modified into: inter prediction coding mode+transform coding, intra prediction coding mode+transform coding, and transform coding mode, and an optimal coding mode for a current layer is determined in the same manner as the main scheme. At the decoding end, an AC coefficient of the current layer is also restored according to the prediction coding mode for the current layer, thereby completing the entire RAHT attribute coding.
(2) In embodiments of the disclosure, an attribute prediction mode may be further modified.

In an embodiment, for any prediction coding mode, whether an inter attribute prediction value is zero is first determined. If the inter attribute prediction value is not zero, a current prediction value is directly used as a prediction value of an AC coefficient of a current node, and otherwise, an AC coefficient obtained through intra prediction is used as the prediction value of the AC coefficient of the current node. In another embodiment, by combining inter prediction values and intra prediction values of different RAHT transform layers, an optimal prediction value may be finally obtained according to different weights, thereby further improving the RAHT coding efficiency of attributes of a point cloud. The specific prediction coding scheme is as follows. Assuming that an RAHT intra prediction value of the current node is predIntraVal and an inter prediction value of the current node is predInterVal, a final prediction value is predVal.

predVal=w1*predIntraVal+w2*predInterVal (33)
(3) In embodiments of the disclosure, an attribute prediction mode may be further modified.

In an embodiment, based on three existing prediction coding modes: an inter prediction coding mode combined with an intra prediction coding mode, the intra prediction coding mode, and a transform coding mode, a coding mode is introduced for a current RAHT coding layer at the encoding end to represent a prediction coding mode to be used for restoring an AC coefficient of the current RAHT coding layer. In another embodiment, a prediction coding modes may be further modified by introducing a coding mode at a slice level: inter prediction coding of attributes of a point cloud of a current picture using point clouds of reference pictures that are subject to local motion compensation and non-local motion compensation. At the encoding end, an optimal encoding mode is adaptively selected based on an RDO algorithm, and at the decoding end, attribute information of a current slice is decoded based on a decoding mode at the slice level.

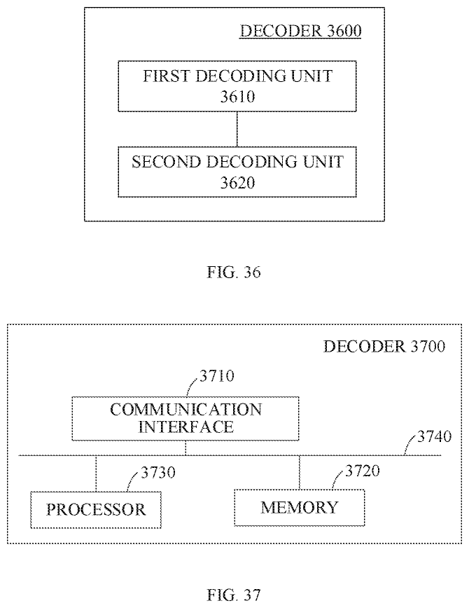

The method embodiments of the disclosure are described in detail above with reference to FIG. 1 to FIG. 35, and apparatus embodiments of the disclosure will be described in detail below with reference to FIG. 36 to FIG. 39. It may be understood that, descriptions of the method embodiments and descriptions of the apparatus embodiments correspond to each other, and therefore, for parts not described in detail, reference can be made to the above method embodiments.

FIG. 36 is a schematic structural diagram of a decoder provided in an embodiment of the disclosure. As illustrated in FIG. 36, the decoder 3600 may include a first decoding unit and a second decoding unit.

The first decoding unit 3610 is configured to parse a bitstream to determine first flag information.

The second decoding unit 3620 is configured to decode attribute information of a current layer according to the first flag information.

The current layer is any one of multiple RAHT layers. The first flag information indicates whether a first decoding manner or a second decoding manner is to be used for the current layer. In the first decoding manner, nodes in the current layer correspond to the same decoding mode. In the second decoding manner, decoding modes for nodes in the current layer need to be determined respectively.

In some implementations, the second decoding unit 3620 is configured to parse the bitstream to determine second flag information, if the first flag information indicates the first decoding manner, where the second flag information indicates a target decoding mode. The second decoding unit 3620 is further configured to decode attribute information of nodes in the current layer according to the target decoding mode. The target decoding mode is one of: an RAHT transform decoding mode; an RAHT intra prediction combined transform decoding mode; an RAHT inter prediction combined transform decoding mode; or a combination of the RAHT intra prediction combined transform decoding mode and the RAHT inter prediction combined transform decoding mode.

In some implementations, the second decoding unit 3620 is configured to determine a decoding mode for a current node in the current layer, if the first flag information indicates the second decoding manner; and decode attribute information of the current node according to the decoding mode for the current node.

In some implementations, the second decoding unit 3620 is configured to determine the decoding mode for the current node according to whether a reference picture contains a collocated node of the current node, if the current layer is located within a first level range of the multiple RAHT layers.

In some implementations, if the reference picture contains the collocated node, the decoding mode for the current node is an RAHT inter prediction combined transform decoding mode; and/or, if the reference picture contains no collocated node, the decoding mode for the current node is an RAHT intra prediction combined transform decoding mode.

In some implementations, an RAHT layer within the first level range is located at a highest level of the multiple RAHT layers.

In some implementations, the second decoding unit 3620 is configured to parse third flag information, if the current layer is located within a second level range of the multiple RAHT layers. The third flag information indicates the decoding mode for the current node.

In some implementations, the decoding mode indicated by the third flag information is one of: an RAHT transform decoding mode; an RAHT intra prediction combined transform decoding mode; or an RAHT inter prediction combined transform decoding mode.

In some implementations, an RAHT layer within the second level range is located at a middle level of the multiple RAHT layers.

In some implementations, the second decoding unit 3620 is configured to determine the decoding mode for the current node according to an adjacent node of the current node, if the current layer is located within a third level range of the multiple RAHT layers.

In some implementations, the second decoding unit 3620 is configured as follows. If the number of adjacent nodes of a parent node of the current node is greater than a first threshold and the number of adjacent nodes of a grandparent node of the current node is greater than a second threshold, the decoding mode for the current node is an RAHT intra prediction combined transform decoding mode; and/or, if the number of adjacent nodes of the parent node of the current node is less than or equal to the first threshold and/or the number of adjacent nodes of the grandparent node of the current node is less than or equal to the second threshold, the decoding mode for the current node is an RAHT transform decoding mode. In some implementations, an RAHT layer within the third level range is located at a lowest level of the multiple RAHT layers.

In some implementations, the first flag information is located in an ABH.

In some implementations, the second decoding unit 3620 is configured to determine an intra prediction value and an inter prediction value of an AC coefficient of a current node in the current layer; determine a target prediction value of the AC coefficient by fusing the intra prediction value and the inter prediction value; and determine reconstructed attribute information of the current node according to the target prediction value.

In some implementations, the second decoding unit 3620 is configured to determine a reconstructed value of the AC coefficient according to the target prediction value of the AC coefficient and a prediction residual value of the AC coefficient; and determine a reconstructed value of attribute information of the current node by performing inverse transform on the reconstructed value of the AC coefficient and a DC coefficient of the current node.

In some implementations, the decoder 3600 further includes a third decoding unit 3630. The third decoding unit 3630 is configured to parse the bitstream to determine fourth flag information. The fourth flag information indicates whether a motion-compensated reference picture is to be used for RAHT inter prediction.

In some implementations, the fourth flag information corresponds to a slice; or, the fourth flag information corresponds to an RAHT layer.

In some implementations, the motion compensation is local motion compensation or global motion compensation.

It may be understood that in embodiments of the disclosure, the “unit” may be part of the circuitry, part of the processor, part of the program or software, etc., and of course may also be a module, or may be non-modular. In addition, various components described in this embodiment may be integrated into one processing unit or may be present as a number of physically separated units, or two or more units may be integrated into one. The integrated unit may take the form of hardware or a software functional module.

If the integrated unit is implemented as a software functional module and not sold or used as a stand-alone product, the integrated unit may be stored in a computer-readable storage medium. Based on such understanding, the technical solution of this embodiment in essential, or a part that contributes to the prior art, or all or part of the technical solution, may be embodied in the form of a software product. The computer software product is stored in a storage medium and includes a number of instructions to enable a computer device (which may be a personal computer, a server, or a network device, etc.) or processor to perform all or part of the operations of the method described in this embodiment. The foregoing storage medium includes a USB stick, a removable hard disk, a read only memory (ROM), a random access memory (RAM), a magnetic disk or an optical disk, and other media that may store program codes.

Thus, embodiments of the disclosure provide a computer-readable storage medium, which is applied to the decoder 3600. The computer-readable storage medium is configured to store a computer program which, when executed by a processor, is operable to implement the decoding method described in any one of the foregoing embodiments.

Based on the above structure of the decoder 3600 and the computer-readable storage medium, reference is made to FIG. 37 which is a schematic diagram of a specific hardware structure of a decoder 3700 provided in embodiments of the disclosure. As illustrated in FIG. 37, the decoder 3700 may include a communication interface 3710, a memory 3720, and a processor 3730. Various components are coupled together via a bus system 3740. It may be understood that, the bus system 3740 is configured to enable connection and communication between these components. The bus system 3740 includes a power bus, a control bus, and a status signal bus in addition to a data bus. For the sake of clarity, however, the various buses are labelled as bus system 3740 in FIG. 37.

The communication interface 3710 is configured to receive and transmit signals during information transmission with other external network elements.

The memory 3720 is configured to store a computer program.

The processor 3730 is configured to, when executing the computer program, parse a bitstream to determine first flag information; and decode attribute information of a current layer according to the first flag information. The current layer is any one of multiple RAHT layers. The first flag information indicates whether a first decoding manner or a second decoding manner is to be used for the current layer. In the first decoding manner, nodes in the current layer correspond to the same decoding mode. In the second decoding manner, decoding modes for nodes in the current layer need to be determined respectively.

It will be appreciated that, the memory 3720 in embodiments of the disclosure may be a transitory memory or non-transitory memory, or may include both transitory and non-transitory memory. In particular, the non-transitory memory may be an ROM, a programmable ROM (PROM), an erasable PROM (EPROM), an electrically EPROM (EEPROM), or a flash memory. The transitory memory may be an RAM, which is used as an external cache. By way of illustration, but not limitation, many forms of RAM are available, such as a static RAM (SRAM), a dynamic RAM (DRAM), a synchronous DRAM (SDRAM), a double data rate synchronous random access memory (DDRSDRAM), an enhanced SDRAM (ESDRAM), a synchlink DRAM (SLDRAM), and a direct Rambus RAM (DRRAM). The memory 3720 of the system and method described in this disclosure is intended to include, but is not limited to, these and any other suitable types of memory.

The processor 3730 may be an integrated circuit chip with signal processing capabilities. During implementation, the operations in the above method may be accomplished by integrated logic circuitry in the hardware of the processor 3730 or by instructions in the form of software. The processor 3730 described above may be a general-purpose processor, a digital signal processor (DSP), an application specific integrated circuit (ASIC), a field programmable gate array (FPGA), or other programmable logic device, discrete gate or transistor logic device, discrete hardware component. The various methods, steps and logic block diagrams disclosed in embodiments of the disclosure may be implemented or performed. The general-purpose processor may be a microprocessor or the processor may also be any conventional processor, etc. The operations in the method disclosed in conjunction with embodiments of the disclosure may be performed directly by the hardware decoder processor or by a combination of hardware and software modules in the decoder processor. The software module may be located in a random memory, flash memory, read-only memory, programmable read-only memory or electrically erasable programmable memory, registers and other storage media mature in the art. The storage medium is located in the memory 3720, and the processor 3730 reads the information in the memory 3720 and completes the operations of the above method in combination with its hardware.

It will be appreciated that these embodiments described in this disclosure may be implemented in hardware, software, firmware, middleware, microcode, or combinations thereof. For hardware implementations, the processing unit may be implemented in one or more ASIC, DSP, DSP Device (DSPD), programmable logic device (PLD), FPGA, general-purpose processor, controller, microcontroller, microprocessor, other electronic unit for performing the functions described in this disclosure, or a combination thereof. For software implementations, the technology described in this disclosure may be implemented by means of modules (e.g. procedures, functions, etc.) that perform the functions described in this disclosure. The software code may be stored in a memory and executed by a processor. The memory may be implemented in the processor or outside the processor.

Optionally, as another embodiment, the processor 3730 is further configured to perform the decoding method described in any one of the foregoing embodiments when executing the computer program.

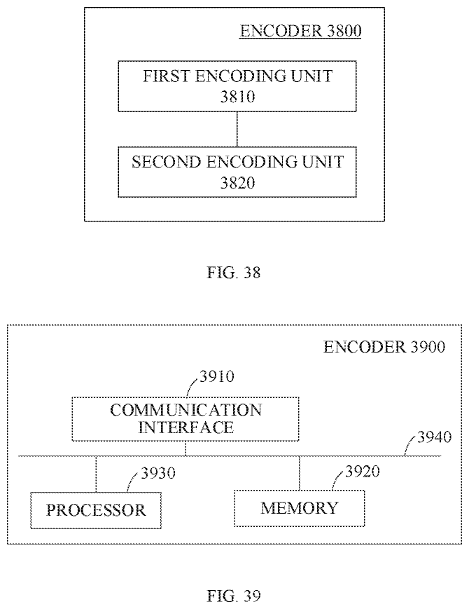

FIG. 38 is a schematic structural diagram of an encoder provided in an embodiment of the disclosure. As illustrated in FIG. 38, the encoder 3800 includes a first encoding unit 3810 and a second encoding unit 3820.

The first encoding unit 3810 is configured to determine a cost of a first encoding manner and a cost of a second encoding manner.

The second encoding unit 3820 is configured to encode attribute information of a current layer according to the cost of the first encoding manner and the cost of the second encoding manner.

The current layer is any one of multiple RAHT layers. In the first encoding manner, nodes in the current layer correspond to the same encoding mode. In the second encoding manner, encoding modes for nodes in the current layer need to be determined respectively.

In some implementations, the encoder 3800 further includes a third encoding unit 3830. The third encoding unit 3830 is configured to signal first flag information in a bitstream. The first flag information indicates the first encoding manner or the second encoding manner.

In some implementations, the second encoding unit 3820 is configured to determine a target encoding mode from multiple encoding modes, if the cost of the first encoding manner is less than the cost of the second encoding manner; and encode attribute information of nodes in the current layer according to the target encoding mode. The multiple encoding modes include at least one of: an RAHT transform encoding mode; an RAHT intra prediction combined transform encoding mode; an RAHT inter prediction combined transform encoding mode; or a combination of the RAHT intra prediction combined transform encoding mode and the RAHT inter prediction combined transform encoding mode.

In some implementations, the encoder 3800 further includes a fourth encoding unit 3840. The fourth encoding unit 3840 is configured to signal second flag information in a bitstream. The second flag information indicates the target encoding mode.

In some implementations, the second encoding unit 3820 is configured to determine an encoding mode for a current node in the current layer, if the cost of the second encoding manner is less than the cost of the first encoding manner; and encode attribute information of the current node according to the encoding mode for the current node.

In some implementations, the second encoding unit 3820 is configured to determine the encoding mode for the current node according to whether a reference picture contains a collocated node of the current node, if the current layer is located within a first level range of the multiple RAHT layers.

In some implementations, the second encoding unit 3820 is configured as follows. If the reference picture contains the collocated node, the encoding mode for the current node is an RAHT inter prediction combined transform encoding mode; and/or, if the reference picture contains no collocated node, the encoding mode for the current node is an RAHT intra prediction combined transform encoding mode.

In some implementations, an RAHT layer within the first level range is located at a highest level of the multiple RAHT layers.

In some implementations, the second encoding unit 3820 is configured to signal third flag information in a bitstream, if the current layer is located within a second level range of the multiple RAHT layers. The third flag information indicates the encoding mode for the current node.

In some implementations, the encoding mode indicated by the third flag information is one of: an RAHT transform encoding mode; an RAHT intra prediction combined transform encoding mode; or an RAHT inter prediction combined transform encoding mode.

In some implementations, an RAHT layer within the second level range is located at a middle level of the multiple RAHT layers.

In some implementations, the second encoding unit 3820 is configured to determine the encoding mode for the current node according to an adjacent node of the current node, if the current layer is located within a third level range of the multiple RAHT layers.

In some implementations, the second encoding unit 3820 is configured as follows. If the number of adjacent nodes of a parent node of the current node is greater than a first threshold and the number of adjacent nodes of a grandparent node of the current node is greater than a second threshold, the encoding mode for the current node is an RAHT intra prediction combined transform encoding mode; and/or, if the number of adjacent nodes of the parent node of the current node is less than or equal to the first threshold and/or the number of adjacent nodes of the grandparent node of the current node is less than or equal to the second threshold, the encoding mode for the current node is an RAHT transform encoding mode. In some implementations, an RAHT layer within the third level range is located at a lowest level of the multiple RAHT layers.

In some implementations, the first flag information is located in an ABH.

In some implementations, the second encoding unit 3820 is configured to determine an intra prediction value and an inter prediction value of an AC coefficient of a current node in the current layer; determine a target prediction value of the AC coefficient by fusing the intra prediction value and the inter prediction value; and determine reconstructed attribute information of the current node according to the target prediction value.

In some implementations, the second encoding unit 3820 is configured to determine a reconstructed value of the AC coefficient according to the target prediction value of the AC coefficient and a prediction residual value of the AC coefficient; and determine a reconstructed value of attribute information of the current node by performing inverse transform on the reconstructed value of the AC coefficient and a DC coefficient of the current node.

In some implementations, the encoder 3800 further includes a fifth encoding unit 3850. The fifth encoding unit 3850 is configured to signal fourth flag information in a bitstream. The fourth flag information indicates whether a motion-compensated reference picture is to be used for RAHT inter prediction.

In some implementations, the fourth flag information corresponds to a slice; or, the fourth flag information corresponds to an RAHT layer.

In some implementations, the motion compensation is local motion compensation or global motion compensation.

It may be understood that in embodiments of the disclosure, the “unit” may be part of the circuitry, part of the processor, part of the program or software, etc., and of course may also be a module, or may be non-modular. In addition, various components described in this embodiment may be integrated into one processing unit or may be present as a number of physically separated units, or two or more units may be integrated into one. The integrated unit may take the form of hardware or a software functional module.

If the integrated unit is implemented as a software functional module and not sold or used as a stand-alone product, the integrated unit may be stored in a computer-readable storage medium. Based on such understanding, the technical solution of this embodiment in essential, or a part that contributes to the prior art, or all or part of the technical solution, may be embodied in the form of a software product. The computer software product is stored in a storage medium and includes a number of instructions to enable a computer device (which may be a personal computer, a server, or a network device, etc.) or processor to perform all or part of the operations of the method described in this embodiment. The foregoing storage medium includes a USB stick, a removable hard disk, an ROM, an RAM, a magnetic disk or an optical disk, and other media that may store program codes.

Thus, embodiments of the disclosure provide a computer-readable storage medium, which is applied to the encoder 3800. The computer-readable storage medium is configured to store a computer program which, when executed by a processor, is operable to implement the encoding method described in any one of the foregoing embodiments.

Based on the above structure of the encoder 3800 and the computer-readable storage medium, reference is made to FIG. 39 which is a schematic diagram of a specific hardware structure of an encoder 3900 provided in embodiments of the disclosure. As illustrated in FIG. 39, the encoder 3900 may include a communication interface 3910, a memory 3920, and a processor 3930. Various components are coupled together via a bus system 3940. It may be understood that, the bus system 3940 is configured to enable connection and communication between these components. The bus system 3940 includes a power bus, a control bus, and a status signal bus in addition to a data bus. For the sake of clarity, however, the various buses are labelled as bus system 3940 in FIG. 39.

The communication interface 3910 is configured to receive and transmit signals during information transmission with other external network elements.

The memory 3920 is configured to store a computer program.

The processor 3930 is configured to, when executing the computer program, determine a cost of a first encoding manner and a cost of a second encoding manner; and encode attribute information of a current layer according to the cost of the first encoding manner and the cost of the second encoding manner. The current layer is any one of multiple RAHT layers. In the first encoding manner, nodes in the current layer correspond to the same encoding mode. In the second encoding manner, encoding modes for nodes in the current layer need to be determined respectively.

It will be appreciated that, the memory 3920 in embodiments of the disclosure may be a transitory memory or non-transitory memory, or may include both the transitory memory and non-transitory memory. In particular, the non-transitory memory may be an ROM, a PROM, an EPROM, an EEPROM, or a flash memory. The transitory memory may be an RAM, which is used as an external cache. By way of illustration, but not limitation, many forms of RAM are available, such as an SRAM, a DRAM, an SDRAM, a DDRSDRAM, an ESDRAM, an SLDRAM, and a DRRAM. The memory 3920 of the system and method described in this disclosure is intended to include, but is not limited to, these and any other suitable types of memory.

The processor 3930 may be an integrated circuit chip with signal processing capabilities. During implementation, the operations in the above method may be accomplished by integrated logic circuitry in the hardware of the processor 3930 or by instructions in the form of software. The processor 3930 described above may be a general-purpose processor, a DSP, an ASIC, an FPGA, or other programmable logic device, discrete gate or transistor logic device, discrete hardware component. The various methods, steps and logic block diagrams disclosed in embodiments of the disclosure may be implemented or performed. The general-purpose processor may be a microprocessor or the processor may also be any conventional processor, etc. The operations in the method disclosed in conjunction with embodiments of the disclosure may be performed directly by the hardware decoder processor or by a combination of hardware and software modules in the decoder processor. The software module may be located in a random memory, flash memory, read-only memory, programmable read-only memory or electrically erasable programmable memory, registers and other storage media mature in the art. The storage medium is located in the memory 3920, and the processor 3930 reads the information in the memory 3920 and completes the operations of the above method in combination with its hardware.

It will be appreciated that these embodiments described in this disclosure may be implemented in hardware, software, firmware, middleware, microcode, or combinations thereof. For hardware implementations, the processing unit may be implemented in one or more ASIC, DSP, DSPD, PLD, FPGA, general-purpose processor, controller, microcontroller, microprocessor, other electronic unit for performing the functions described in this disclosure, or a combination thereof. For software implementations, the technology described in this disclosure may be implemented by means of modules (e.g. procedures, functions, etc.) that perform the functions described in this disclosure. The software code may be stored in a memory and executed by a processor. The memory may be implemented in the processor or outside the processor.

Optionally, as another embodiment, the processor 3930 is further configured to perform the encoding method described in any one of the foregoing embodiment when executing the computer program.

Embodiments of the disclosure further provide a computer-readable storage medium, where the computer-readable storage medium is a non-volatile computer-readable storage medium storing a bitstream. The bitstream is generated according to an encoding method for an encoder or decoded according to a decoding method for a decoder. The decoding method may be the decoding method described in any one of the foregoing embodiments, and the encoding method may the encoding method described in any one of the foregoing embodiments.

It may be noted that in this disclosure, the terms “include”, “comprise” or any other variant thereof are intended to cover non-exclusive inclusion, such that a process, method, article or apparatus comprising a range of elements includes not only those elements, but also includes other elements that are not explicitly listed or are also inherent to such a process, method, article or apparatus. Without further limitation, an element qualified by the statement “including a . . . ” does not preclude the existence of another identical element in the process, method, article or apparatus including that element.

The above serial numbers of the embodiments of the disclosure are for descriptive purposes only and do not represent the merits of the embodiments.

The methods disclosed in the several method embodiments provided in this disclosure may be combined in any way to obtain new method embodiments without conflict.

The features disclosed in the several product embodiments provided in this disclosure may be combined in any way to obtain new product embodiments without conflict.

The features disclosed in several method or apparatus embodiments provided in this disclosure may be combined in any way to obtain new method embodiments or apparatus embodiments without conflict.

The foregoing is only a specific implementation of the present disclosure, but the scope of protection of the present disclosure is not limited thereto, and any variation or substitution readily conceivable by any person skilled in the art within the technical scope disclosed in the present disclosure shall be covered by the scope of protection of the present disclosure. Accordingly, the scope of protection of this disclosure shall be governed by the scope of protection of the stated claims.

What is claimed is:

1. A point cloud decoding method, applied to a decoder and comprising:
parsing a bitstream to determine first flag information; and
decoding attribute information of a current layer according to the first flag information;
wherein the current layer is any one of a plurality of region adaptive hierarchical transform (RAHT) layers, the first flag information indicates whether a first decoding manner or a second decoding manner is to be used for the current layer, in the first decoding manner, nodes in the current layer correspond to a same decoding mode, and in the second decoding manner, decoding modes for nodes in the current layer need to be determined respectively.

2. The method of claim 1, wherein decoding the attribute information of the current layer according to the first flag information comprises:
parsing the bitstream to determine second flag information, in response to the first flag information indicating the first decoding manner, wherein the second flag information indicates a target decoding mode; and
decoding attribute information of nodes in the current layer according to the target decoding mode;
wherein the target decoding mode is one of:
an RAHT transform decoding mode;
an RAHT intra prediction combined transform decoding mode;
an RAHT inter prediction combined transform decoding mode; or
a combination of the RAHT intra prediction combined transform decoding mode and the RAHT inter prediction combined transform decoding mode.

3. The method of claim 1, wherein decoding the attribute information of the current layer according to the first flag information comprises:
determining a decoding mode for a current node in the current layer, in response to the first flag information indicating the second decoding manner; and
decoding attribute information of the current node according to the decoding mode for the current node.

4. The method of claim 3, wherein determining the decoding mode for the current node in the current layer comprises:
determining the decoding mode for the current node according to whether a reference picture contains a collocated node of the current node, in response to the current layer being located within a first level range of the plurality of RAHT layers.

5. The method of claim 4, wherein:
in response to the reference picture containing the collocated node, the decoding mode for the current node is an RAHT inter prediction combined transform decoding mode; and/or
in response to the reference picture containing no collocated node, the decoding mode for the current node is an RAHT intra prediction combined transform decoding mode.

6. The method of claim 4, wherein an RAHT layer within the first level range is located at a highest level of the plurality of RAHT layers.

7. The method of claim 3, wherein determining the decoding mode for the current node in the current layer comprises:
parsing third flag information, in response to the current layer being located within a second level range of the plurality of RAHT layers, wherein the third flag information indicates the decoding mode for the current node.

8. The method of claim 7, wherein the decoding mode indicated by the third flag information is one of:
an RAHT transform decoding mode;
an RAHT intra prediction combined transform decoding mode; or
an RAHT inter prediction combined transform decoding mode.

9. The method of claim 7, wherein an RAHT layer within the second level range is located at a middle level of the plurality of RAHT layers.

10. The method of claim 3, wherein determining the decoding mode for the current node in the current layer comprises:
determining the decoding mode for the current node according to an adjacent node of the current node, in response to the current layer being located within a third level range of the plurality of RAHT layers.

11. The method of claim 10, wherein:
in response to a number of adjacent nodes of a parent node of the current node being greater than a first threshold and a number of adjacent nodes of a grandparent node of the current node being greater than a second threshold, the decoding mode for the current node is an RAHT intra prediction combined transform decoding mode; and/or
in response to the number of adjacent nodes of the parent node of the current node being less than or equal to the first threshold and/or the number of adjacent nodes of the grandparent node of the current node being less than or equal to the second threshold, the decoding mode for the current node is an RAHT transform decoding mode.

12. The method of claim 10, wherein an RAHT layer within the third level range is located at a lowest level of the plurality of RAHT layers.

13. The method of claim 1, wherein the first flag information is located in an attribute brick header (ABH).

14. The method of claim 1, wherein decoding the attribute information of the current layer comprises:
determining an intra prediction value and an inter prediction value of an alternating current (AC) coefficient of a current node in the current layer;
determining a target prediction value of the AC coefficient by fusing the intra prediction value and the inter prediction value; and
determining reconstructed attribute information of the current node according to the target prediction value.

15. The method of claim 14, wherein determining the reconstructed attribute information of the current node according to the target prediction value comprises:
determining a reconstructed value of the AC coefficient according to the target prediction value of the AC coefficient and a prediction residual value of the AC coefficient; and
determining a reconstructed value of attribute information of the current node by performing inverse transform on the reconstructed value of the AC coefficient and a direct current (DC) coefficient of the current node.

16. The method of claim 1, further comprising:
parsing the bitstream to determine fourth flag information, wherein the fourth flag information indicates whether a reference picture after motion compensation is to be used for RAHT inter prediction.

17. The method of claim 16, wherein:
the fourth flag information corresponds to a slice; or
the fourth flag information corresponds to an RAHT layer.

18. The method of claim 16, wherein the motion compensation is local motion compensation or global motion compensation.

19. A decoder, comprising:
at least one processor; and
a memory, coupled to the at least one processor and storing at least one computer executable instruction which, when executed by the at least one processor, causes the at least one processor to:
parse a bitstream to determine first flag information; and
decode attribute information of a current layer according to the first flag information;
wherein the current layer is any one of a plurality of region adaptive hierarchical transform (RAHT) layers, the first flag information indicates whether a first decoding manner or a second decoding manner is to be used for the current layer, in the first decoding manner, nodes in the current layer correspond to a same decoding mode, and in the second decoding manner, decoding modes for nodes in the current layer need to be determined respectively.

20. An encoder, comprising:
at least one processor; and
a memory, coupled to the at least one processor and storing at least one computer executable instruction which, when executed by the at least one processor, causes the at least one processor to:
determine a cost of a first encoding manner and a cost of a second encoding manner; and
encode attribute information of a current layer according to the cost of the first encoding manner and the cost of the second encoding manner;
wherein the current layer is any one of a plurality of region adaptive hierarchical transform (RAHT) layers, in the first encoding manner, nodes in the current layer correspond to a same encoding mode, and in the second encoding manner, encoding modes for nodes in the current layer need to be determined respectively.
